(19) United States
(12) Patent Application Publication
(10) Pub. No.: US 2005/0071283 A1
(43) Pub. Date: Mar. 31, 2005

(54) Quality assured secure and coordinated transmission of separate image and data records representing a transaction

(76) Inventors: William M. Randle, Bexley, OH (US); Randall E. Orkis, Pataskala, OH (US)

Correspondence Address: Edwin M. Baranowski;Porter Wright Morris & Arthur LLP, Suite 3100, 41 South High Street, Columbus, OH, 43215, US

(21) Appl. No.: 10/823,442

(22) Filed: Apr. 12, 2004

Related U.S. Application Data
(63) Continuation-in-part of application No. 10/459,694, filed on Jun. 11, 2003.
(63) Continuation-in-part of application No. 10/283,038, filed on Oct. 25, 2002.
(63) Continuation-in-part of application No. 09/578,329, filed on May 25, 2000.

(51) Int. Cl. G06F 17/60

(52) U.S. Cl. 705/75

(57) ABSTRACT

A system and method of securely processing an electronic transaction in which an image and data associated with the transaction are separately processed and 1) a legally acceptable substitute record of the transaction may be recreated at any step in processing, 2) unauthorized access to the image, data and or substitute document is detectable, 3) quality assurance of the image and data is provided, and 4) participants in a network may create additional security for the transactions.

### RELATED APPLICATIONS

This application is a continuation-in-part of co-pending applications Ser. No. 10/459,694, filed on Jun. 11, 2003, Standardized Transmission and Exchange of Data with Security and Non-Repudiation Functions, a continuation-in-part of application Ser. No.10/283,038, Dialect Independent Multi Dimensional Integrator Using a Normalized Language Plafform and Secure Controlled Access, filed on Oct. 25, 2002, and a continuation in part of application Ser. No. 09/578,329, Secure E-Commerce System with Guaranteed Funds and Net Settlement, filed on Feb. 25, 2000, all of which are herein incorporated by reference.

### FIELD OF THE INVENTION

The present invention relates generally to electronic transaction processing, particularly to financial instruments and transactions translated into electronic format and associated procedures such as secure, accurate and verified imaging of financial instruments, check truncation and electronic funds payment, settlement and clearing.

### BACKGROUND AND SUMMARY OF THE INVENTION

As used herein the following terms, in addition to their literal meaning, are not limiting, but are used for convenience and defined below to include at least the following:

“bank” refers to a bank, savings association, credit union, and other financial institutions including government, government appointed agencies and departments, corporations owned and operated by or for banks or other financial institutions, and their affiliates, independent processing centers or corporations, mass market retailers, clients, intermediaries and participants or any electronic technology or 3equipment connected to any of the listed agencies, entities or persons, and any person or entity that accepts items as tender or payment, including but not limited to merchants and the like.

“branch” includes satellite offices of a bank, subsidiaries of banks, and includes, but is not limited to ATMs, lockboxes, remote terminals performing financial. functions, corporate customers, retail customers, retail institutions, and the like.

“check” includes all types of negotiable financial instruments and related instruments such as deposit slips, cash letter, cash in/out tickets, balances, payment and loan coupons, etc., and any other paper document representing a transaction or funds transfer. Financial instrument” is a FASB defined term (FAS No. 107).

“check processing” includes writing, receipt, capture, clearing and settlement, transmission, synchronization, re-presentment, exception processing, reporting, validating, archiving, retrieval, credit and debit card transactions, lines of credit, smart cards, other paper, plastic or electronic payment instrument processing, deposit transactions, information transactions, such as those related to privacy and security, and the like.

“check writer” is equivalent to “payor” and includes a bank customer, account holder, customer, consumer, and the like having an ability to draw on funds maintained in an account;

“depository bank” is the bank of first deposit of a check.

“MICR” (magnetic ink character recognition), “imager” and “scan(ner)” include any character recognition technology including optical and the like, bar codes and all other technology now or in the future.

“electronic check” includes one or more files or data streams containing the image of the paper check and or associated data,

“payee” is an individual, party or other entity to which a funds transfer is made by a payor.

“payee bank” is the bank holding the payee's funds or credit account.

“payor bank” is the bank or financial institution on which a check is drawn.

“Shared Multi-Function Service Network” is a multipurpose network or the like supporting multiple functions and applications as defined by services and domains of users. Current networks are application specific and user community specific. Examples of application specific networks include: ATM networks, image exchange networks, FED Wire, SWIFT, VISA, Master Card, Plus, Cirrus, Chips, etc. Application specific networks further include security, performance, management, or business concerns functions in relation to the activities on the network. The Shared Multi-Function Services Network provides services, defined in terms of end users, business relationships and the like, to take the place of applications to establish a shared infrastructure without compromising application specific data or business relationships. Services in the Network are defined in terms of one to one relationships, one to many, many to one, and many to many. To assure performance, quality of service may be defined in terms of users, services, and/or user communities on the network.

“teller” includes teller windows at traditional banks, similar portals, branches, data terminals, and or any image enabling point-of-presentment or point-of-sale now existing or in the future, including but not limited to kiosks, ATMs, cash vaults, merchant and corporate locations, end users, and the like, which may be operatively interconnected to an integrated system via the Internet, the World Wide Web, an intranet, a direct link, an indirect link such as wireless and RFID devices (e.g., Speedpass®), and the like, a private portal, and the like; “teller” includes an imaging and data capture device and optionally a device to input and view events.

“transaction” is not limited to financial transactions but includes any activity associated with the creation, retrieval, updating and deletion of data.

The traditional settlement of a negotiable instrument, such as the deposit and payment of a traditional check tendered for an amount due, is accomplished in accordance with well established procedures. Most checks are preprinted with a line of magnetic characters for use with magnetic ink character recognition (MICR). In most cases, the characters designate the bank upon which the check is drawn, the account number of the check writer, and the number of the check. The MICR line may also include options items such as amount in certain types of checks, such as commercial checks. Other indicia technology, such as bar code and RFID are also supported in addition to or as a replacement for MICR.

When a check is presented to a bank (the depository bank), the bank may add additional information, such as the amount of the check and a bank identifier, and sorts and bundles the paper checks. The depository bank prepares a cash letter for each bundle of checks sorted, or a cash letter that accompanies a group of check bundles. A cash letter may accompany a single bundle of checks or more than one bundle of checks. A typical cash letter contains routing information, the number and total dollar amount of the checks in a particular bundle, and optional additional information. The cash letters and check bundles are then entered into the payment system.

The checks proceed through the system and are cleared by sending each check to the bank on which it is drawn (the payor bank), where it is charged against the check writer's account. The depository bank directly or indirectly routes the check through the payment system, which may include sending the check to the payee's bank, to a related bank, a government entity, and the like. When the check is received by the payor bank, it is validated and the funds are debited from the check writer's account. Validation includes information needed with respect to legal precedence for the settlement and/or challenge of the transaction. The payor bank may archive the paper check or a copy of the check at its location or that of a third party, and/or return the paper check or an electronic representation of the check to the check writer.

Under the Federal Reserve Net Settlement System, banks exchange their customers' checks over a network of regional check processing centers. Typically, a west coast bank cashing a check drawn on an east coast bank sends the check to the processing center nearest the west coast bank. The check is directed to a processing center closest to the east coast bank, which forwards the check to the east coast bank, where the check writer's account is debited. After debiting, the route is reversed and the amount of the check credited to account of the west coast's check casher. Net settlement is delayed in that deposits are not available until the actual check returns, causing not only delay, but also the potential for fraud in attempting to track down bogus or cancelled accounts and the expense of transferring the paper check.

The multiple steps in the traditional paper processing and handling of checks, and in the preparation and transmission of cash letters, result in the float of funds represented by the checks. Float is the time cost of money following the deposit of the check by the payee at the depository bank until actual payment of the funds is accomplished by withdrawing the amount from the check writer's account at the payor bank, whereupon the funds become available for use by the payee. If the check is dishonored by the payor bank, the check is returned through the clearing system in a reverse direction, directly or indirectly, from payor bank to the depository bank. The depository bank debits the payee's account for the dishonored check. The route of the dishonored check from payor to depository bank need not precisely retrace the route of the check from depository bank to payor bank, but may be a direct return from payor bank to depository bank or may follow an indirect route. Dishonored checks typically occur due to insufficient funds in the check writer's account, a stop payment order in place for the particular check, and the like.

The process of exchange and clearing and settlement of checks is tedious because of the volume of transactions and new payment instruments developed to meet commercial needs. Currently, a depository bank is required to physically present and return original checks to the payor bank. After a payee deposits a check that is ultimately received by the payee's bank, the bank typically transports the physical check from a remote location, such as a branch, ATM, etc. where it was received, to a single location, such as a main office, operations center, or contracted site. The check may then be sent to at least one intermediary, such as a reserve bank, a correspondent bank, a clearinghouse, or the like, for collection before it is ultimately delivered to the payor bank. For each transfer, the check must be physically shipped to its destination (the payor bank or it representative).

The current paper-based approach to check handling is labor intensive and costly. The cost of shipping, storing, retrieving and handling the physical paper is expensive. In addition, due to the physical movement of the paper, the current system is not timely. To address this problem, truncation of the physical handling of checks at some point in processing and the substitution of an electronic record in lieu of the paper check at a point in the payment, settlement and clearing process is being implemented. One example is voluntary truncation, where a consumer of a payor bank agrees not to receive their physical cancelled checks and allows the bank to send only a statement or an electronic representation of the check. Another example is electronic paper check conversion, where a paper check is converted into an electronic funds transfer transaction for settlement by use by participants of the Automated Clearing House system. Here, a merchant scans a customer's check to capture the MICR account information and demographics. Upon approval of the check transaction, the customer signs an Electronic Funds Transfer (EFT) authorization receipt, which allows a debit to the customer's account and a credit to the merchant's account. Upon signature of the EFT, the check is no longer a negotiable instrument and is returned to the customer. Upon signing the EFT, the transaction is no longer considered a check transaction and is governed by another less restrictive set of regulations that may not meet the original needs of the user.

New regulations to relieve the problems of handling paper checks allow a bank to destroy a paper check and use an image as the negotiable instrument as long as it has to capacity to provide an Image Replacement Document (IRD) for the original check. Under these regulations, the paper check can be stopped at any location in the collection chain. The bank replaces the paper check with an electronic message containing the transaction information and an electronic image of the check suitable for IRD creation—a paper copy made from the original check or from an electronic image of the original paper check suitable for processing via the traditional paper methods—and sends the substitute check on to another bank that does not have the capability to process checks electronically to continue the settlement and clearing process. The regulations provide that the original paper check is no longer required to be returned to the payor bank, the substitute check is sufficient.

Mechanisms exist for transferring check transaction data electronically between banks and include creating a data file of the transaction information and capturing the front and back image of the paper check and converting it to an electronic format. Transaction information and images sent electronically must conform to the regulations and preferably be cost effective. A need exists for a system to transmit check financial data and images for clearing and settlement quickly, at a low cost, with low risk, and within regulations.

Transaction data may be captured and converted to an electronic file that is relatively small, requiring about 4 k bytes or less. An image of the check itself, on the other hand can be ten to twenty times or more larger than the transaction data file. Transmitting images presents challenges because the size of the file requires a substantial amount of time to transmit electronically. Currently, tampering and duplication are problems in that encryption is not required or standard. Most branches are networked to a bank via a 56K modem designed for electronic data transmissions, not image transmissions. Sending image files may overwhelm the network. Storing image files requires large amounts of storage capacity, causing time problems, creating slowdowns of transmissions sharing the transmission line, and creating expenses.

Quality assurance (QA) for check imaging is necessary to insure that the image file is a true and readable representation of the paper check, that the IRD, once created, has not been tampered with, that non-repudiation of the actual check and transaction (electronic or paper) are supported, that the transaction is uniquely associated with the check (IRD or electronic), and that there is one and only one unique transaction or transaction set for the data and image item(s) captured from the paper check. Quality assurance is also necessary for check re-submittal and associated stamps or endorsements.

The quality of an image is relative to its proposed use; the QA needed for a photo quality digital image that may be used for a poster is quite different from that needed for a relatively low resolution check image. An image that is acceptable for one use may be inappropriate for another. As such, standards for image processing are tailored to the specific needs of the application to assure that the required quality for the intended use is met. Many factors affect the quality of digital images, including the quality of the original material, type and performance of capture device, operator skill, scanning resolution, scanning consistency, post-capture image manipulation, color management, choice of image-format, compression algorithms, and the like.

Digital image quality is usually determined by the required detail of the final image, related artifacts, and cost. For example, higher image quality requires accompanying increases in resolution and color depth, which expands the image's file size and, consequently, the amount of storage space required to store the file. Higher quality also requires increased processing power to manipulate or machine process the image. Similarly, inspecting and optimizing individual images by human means adds to personnel time and the overall cost of operations.

The large volume of checks used for transactions mandates a method to quickly and efficiently capture and confirm check image quality as well as a level of quality assurance for that item as it moves through the banking system. In check processing, the need for speed, low cost computing, minimized storage, and a quality image that can be used as a legal replacement for the paper check are critical to achieving a solution that meets the need. In addition, image quality in terms of capture resolution (optical and pixel or color depth), capture device quality (specifications such as the Modulation Transfer Function of the device), image format, compression techniques, associated meta data, and the like are significant.

A need exists for a process that allows for maximum quality to meet the requirements for replacing a traditional check at the lowest possible cost. For example, the variation in capture points, e.g., a point of sale contrasted with a back room or high volume item processing, can drive the overall quality assurance solution for that collection point. The equipment and correlation/decision metrics may be different due to environmental characteristic variations. Nevertheless, the process encompasses the establishment of expected quality results for that activity and an assessment of their correlation to actual results.

A need exists for a system that allows the destruction of the paper check early in check processing to lower operational costs. Today, paper checks must be moved from the point of presentment to a processing center and then forwarded to the bank of origin. By eliminating these steps through use of a dependable digital image and transaction file, a cost savings would result. The time saved as a result of validated digital movement of the image and data associated with the transaction would allow processors to settle and move funds multiple times throughout the day or in real time straight through processing.

The quality of the digital image is a concern for sending institutions. The banking industry must be able to exchange check images to produce substitute checks that have the same legal standing as the original. The capture of an image must meet usable quality standards to qualify as an IRD and verify the quality of images received from other banks.

The combination of meeting the requirements of the Check Truncation Act and offering a secure, reliable low cost quality assurance (QA) for image and transaction processing would enable bank to bank and bank to customer real time clearing and settlement.

The ability to leverage a Shared Multi-Function Service Network to support the movement, settlement, clearing, archiving, and retrieval of digital information among a broad group of network participants would provide additional savings. Shared Multi-Function Service Networks establish the dedicated infrastructure, software, and support structures to administer, monitor and manage each and every service on the network. Shared Multi-Function Service Networks would allow further efficiencies, fraud reduction, and reduced cost by supporting the ability to manage cash position in real or near real time, which would result in a significant change in terms of operations and resulting product offerings for the financial services industry and its customers as well as other industries that could leverage services on, or provide services to the Network.

Accordingly, in fulfilling the aforementioned needs, the present invention allows for the processing of transaction data related to a paper check and an image of a paper check via separate paths with full non-repudiation, with the ability to show tampering and the ability to re-assemble the image and the data to recreate the transaction at any step in check processing. The system includes the isolation of and processing of images separately from transaction data related to the paper check as well as transaction artifacts, such as information and associated elements (like a cash letter) for a given transaction or a net set of transactions needed for check processing, such as settlement and clearing. The system can recombine the image and data for settlement and clearing at any step in the process.

The present invention reduces network impacts due to ability to separate image and transaction data related to a paper check. Real-time and store-and-forward processing of check images are supported both separately or combined with the transaction data related to the paper check. In that image files are much larger than files containing transaction data related to the paper check, the ability to send the image and data separately and later reconnect and recombine allows for optimized network bandwidth utilization using current networks between systems interfaces and thereby reduces or eliminates the need for costly network upgrades. The ability to send the image and data separately and later reconnect and recombine also supports network and system quality of service partitioning that are driven by business processing priorities and time sensitive information to include fraud and customer behavior patterns.

The present invention comprises a unique digital signature algorithm that utilizes multiple characteristics of the transaction data related to the paper check and image data sets to create a unique digital signature for the overall transaction set as well as the individual components associated with the transaction. This digital signature process supports security features such as non-repudiation and the ability to show tampering at any step of check processing, including the settlement and or clearing process. The present invention provides the ability to leverage a standard IP network for secure and non-reputable services or application specific activities that are secured from use or observance from any other user or node on the network outside of those users defined for a specific service or application activity, including, but not limited to a private secure network, the Internet, the World Wide Web, and the like. The present invention includes a non-repudiation function with the ability to uniquely digitally sign each component of a transaction and allows for exception processing in the case of transaction repudiation. The present invention allows for exception processing, such as rejecting the transaction, if tampering is detected.

The present invention also provides for the maintenance and enforcement of access control lists and services definitions independent of services defined for the entire network. This capability provides a means to further allow only specific users beyond that provided by the network application layer and is available to the end user on a network node within their firewall and not observable to anything or anyone on the network on the other side of the firewall.

The present invention creates, manages and operates a multipurpose services based network that can support real time and or batch any to any end point secure communications for the purpose of check processing, such as but not limited to payments, settlement and clearing, and image exchange on the same network infrastructure.

The present invention includes the functions of quality assurance of images and data captured and automated and/or manual exception processing based on image quality to identify paper checks that must be further processed prior to destruction.

The present invention allows banks to do business directly with other banks supported by common security and technology. A bank may offer any service to any other bank that it chooses, such as current functions, including Item Verification, Funds Transfer, Image Exchange, Check Truncation (Item Processing), Cash Vault Management, Transaction Processing and Net Settlement, as well as services developed in the future. The present invention enables banks the ability to access non-bank services. The system is not application specific or limited to any one function.

The present invention offers value to service providers such as Identity Management Services, Fraud Protection Analysis and Reduction, Unified Messaging, Value Proposition, Cost Reduction from non-bank Offered Services, such as guaranteed funds for presented items (insurance of un cleared items), Federal Reserve Fees, Regulation, the Patriot Act, the Graham-Leach-Bliley Act, Market Values, Real-time Any to Any Banking, Images, Secure Web Services, Information Exchange and the like.

The invention is described more fully in the following description of the preferred embodiment considered in view of the drawings in which:

### BRIEF DESCRIPTION OF THE SEVERAL VIEWS OF THE DRAWINGS

FIG. 1 shows a flow chart sequence of a check entering, being processed and exiting in accordance with the invention when a funds transfer is effected.

FIG. 2 depicts features of the invention.

FIG. 3 is a flow chart representing a quality assurance process.

FIG. 4 depicts the quality assurance process using a single attribute.

FIG. 5A illustrates a personal check; FIG. 5B, FIG. 5C, FIG. 5D and FIG. 5E illustrate other financial instruments related to the check shown in FIG. 5A.

FIG. 6 depicts a data transfer sequence of the invention showing data capture, transactions and the interactions of the components.

FIG. 7.1 through FIG. 7.20 are screen prints representing the sequence of procedures used in an example of transaction processing at a teller station with a scanner connected to the network in accordance with the invention. As more particularly described below, FIGS. 7.1 through 7.10 depict activities accomplished with the invention; FIGS. 7.11 through 7.20 depict reports generated in the invention:

FIG. 7.1 shows an example screen print of a teller station Logon GUI. The teller channel is an example. Overall, the invention may be adapted to support use by any image-enabled point-of-presentment (POP) such as an ATM, a merchant, corporate treasury management, etc. Logging into the environment establishes a user's beginning cash position, authorizes their username/password combination, and defines the location by routing transit. Once logged in to the simulated teller environment, all cash type transactions (cash checks, cash deposits) use the routing transit number (RTN) from the user's login to construct cash-in and cash-out tickets. Additionally, all cash transactions affect the user's cash position within the enterprise server that allows an institution to monitor all cash positions down to a specific user, ATM, or merchant level.

FIG. 7.2 shows a successful logon. The new transaction screen is displayed with the newly established cash drawer identifier, used by all subsequent transactions during the life of this session. The indicia shown are: 1) Deposit, a paper-item deposit transaction supporting the deposit of multiple checks; 2) Cash, a cash check transaction presenting a check for cash; and 3) Cancel, to cancel a transaction previously executed on the terminal.

FIG. 7.3 shows a Cash Check, On-We screen. Selecting the “For Cash” transaction, a check is scanned through an image-enabled check scanner. The MICR is parsed and pre-populated into their appropriate fields. If CAR/LAR technology is available, the amount will also be pre-populated, otherwise the amount is hand entered. The image is also displayed for the user.

FIG. 7.4 is the Cash Check, On-We success screen. Upon selecting the “submit” button, the image and transaction information is sent to a local server for processing. The local server detaches the image from the transaction, stores both in its local database, digitally signs the transaction and each item within the transaction and, finally, forwards the financial transaction information to the enterprise server. The enterprise server first validates the signature on the transaction and each item to verify tampering has not taken place between network endpoints. It then identifies the transaction based upon its target RTN and item type. Via its sorting and routing algorithms, the enterprise server then forwards the transaction to its target validation service where an owning institution of the check is found and validates the item (account, amount, item number, etc.). Upon successful return from the target destination, the enterprise commits the transaction and item data to its database, stamps a synchronized timestamp and replies to the local server. The local server receives a successful reply from the enterprise server, stamps its copy of the transaction with a synchronized timestamp and replies, successfully, to the simulated teller environment.

FIG. 7.5 is a Cash Check, Not On-Us or On-We screen. In this instance the RTN is one that is not recognized by the enterprise server's sorting and routing algorithms. This circumstance forces the enterprise server to reject the item because its target destination is not known.

FIG. 7.6 shows a Cash Check, Not On-Us or On-We rejected screen, a result in which the enterprise server rejects the transaction because of an unknown target destination.

FIG. 7.7 shows a Cash Check, Not On-Us or On-We Override screen resulting from an instance in which an institution allows a good customer to cash a check that is otherwise determined to be not known.

FIG. 7.8 shows a Cash Check, Not On-Us or On-We success screen. Here, the enterprise server recognizes the existence of an override field and approves the transaction.

FIG. 7.9 shows a deposit screen. The local and enterprise servers recognize and treat a deposit just as the others. The difference in a deposit transaction (aside from transaction type codes) is the existence of potentially more items than a cashed check. A check and a deposit ticket are scanned into the simulated teller environment and submitted to the local server for processing.

FIG. 7.10 shows a deposit—success screen. The deposit ticket RTN is recognized as able to be processed by an institution and is approved. Leveraging the invention's sort/routing algorithms, it is feasible to process another institution's deposits, offering a fee generating opportunity for an institution.

FIG. 7.11 shows a Cash Balance Report in which two cash-out items taken down from the initial login cash balance are shown to provide a current drawer position.

FIG. 7.12 is a Pre-Synchronization Database Comparison Report. The local server does not send the image in real-time with the transaction data. It can be configured, via a property setting, to send images in real-time. This screen depicts a comparison of the data stored in the local server (left) and the enterprise server (right). Both contain the transaction financial information, but only the local server has the image. By selecting the “Synchronize” button, the synchronization agent is launched on the local server to feed the images to the enterprise server. This can be scheduled or can be managed by another application that monitors network traffic and launches when there is available bandwidth.

FIG. 7.13 shows the screen while execution of the Synchronization Agent is in process.

FIG. 7.14 shows a Post-synchronization Comparison. Following completion of the synchronization agent, the “Refresh” button presents a screen and can show how the image has moved to the enterprise server for distribution to the appropriate endpoints, i.e., an institution's image archive or another institution for which the first has cashed a check.

FIG. 7.15 is an Item Routing Administration Report. The enterprise server contains a number of sorting and routing algorithms. The reports suite provides an administration facility for defining destinations and services based upon RTN and item type.

FIG. 7.16 is a Transaction Viewer Report. This screen provides a look at the transactions stored within the enterprise server. In this Figure the deposit transaction performed is drawn up and the image of the deposit ticket is displayed.

FIG. 7.17 is an IRD Creation Report in which an Image Replacement Document, IRD, is derived from the image and transaction information captured during processing.

FIG. 7.18 is a Cash Letter Report. The screen capture shows the capability of the invention to generate cash letter reports for feeding into a settlement application.

FIG. 7.19 shows a Sample Report Offering screen. The invention may be adapted to offer a number of ways to view the information captured by the overall system as shown in the report listing.

FIG. 7.20 is an All Items Report showing each transaction, its debits, credits, and net totals.

FIG. 8 is represents the Shared Multi-function Services Network of the invention.

FIG. 9 depicts a participant linked in the Shared Multi-Function Services Network.

### DETAILED DESCRIPTION OF THE INVENTION

The present invention comprises a system and method of processing transaction data related to a paper check and an image of the paper check independently of each other with the ability to combine the image and the data to recreate a legal substitution of the paper check at any step in check processing. The present invention provides quality assurance and the ability to show non-authorized access to any of the individual data or combined data at any step in check processing. The present invention further provides means to create node access control lists beyond those established for given nodes in a network for such uses as straight through processing of checks.

In an embodiment of the present invention, the system allows for secure check truncation at the point of presentment or any other step in the item processing chain by creating a file containing an image of the check and a file containing transaction data related to the paper check, each of which can be transmitted together or separately in a network and subsequently uniquely matched and or integrated for check processing. The system provides a pointer to the location of the image file and/or the transaction data file related to the paper check whether sent together, sent separately and or reintegrated, for check processing.

The invention offers overall efficiency of check processing by potentially eliminating the physical transportation of paper checks and allowing immediate transfer of transaction data related to the paper check followed by a transmission of an image linked to the data.

The image file may include data to meet standards for IRD creation, or may be combined with a data file, such as one containing MICR, net deposit information and the like. Alternatively, the image file may include all required information, such as in the case of a bar coded document or MICR encoded check and the like.

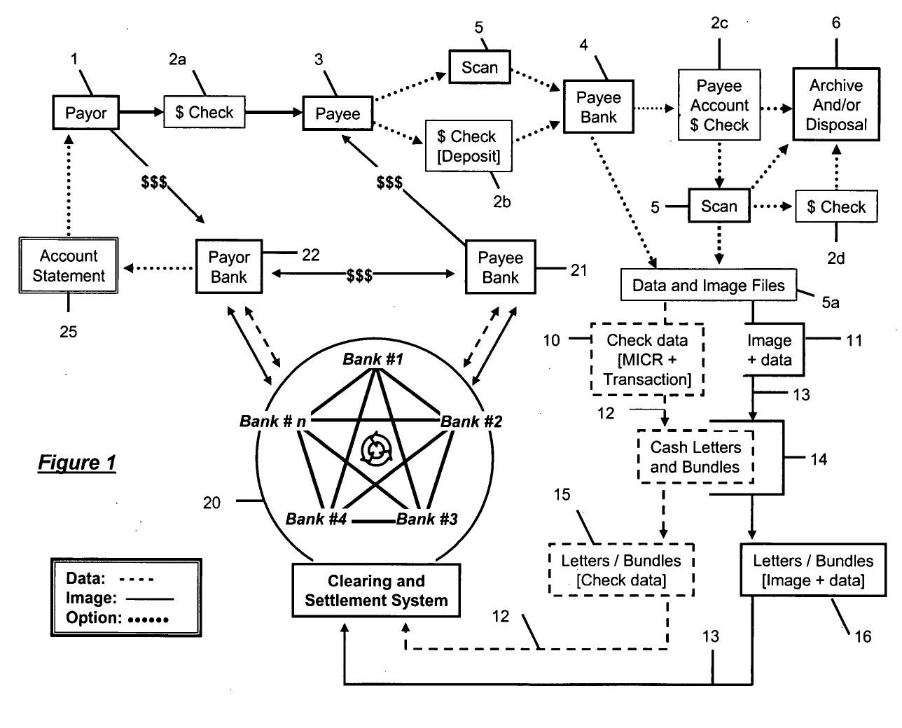

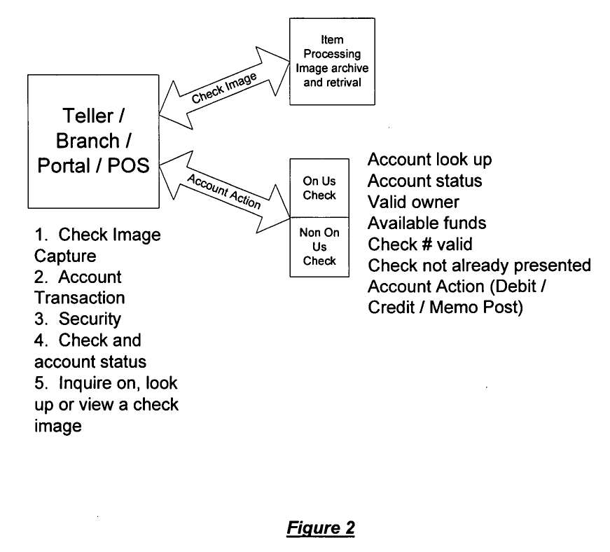

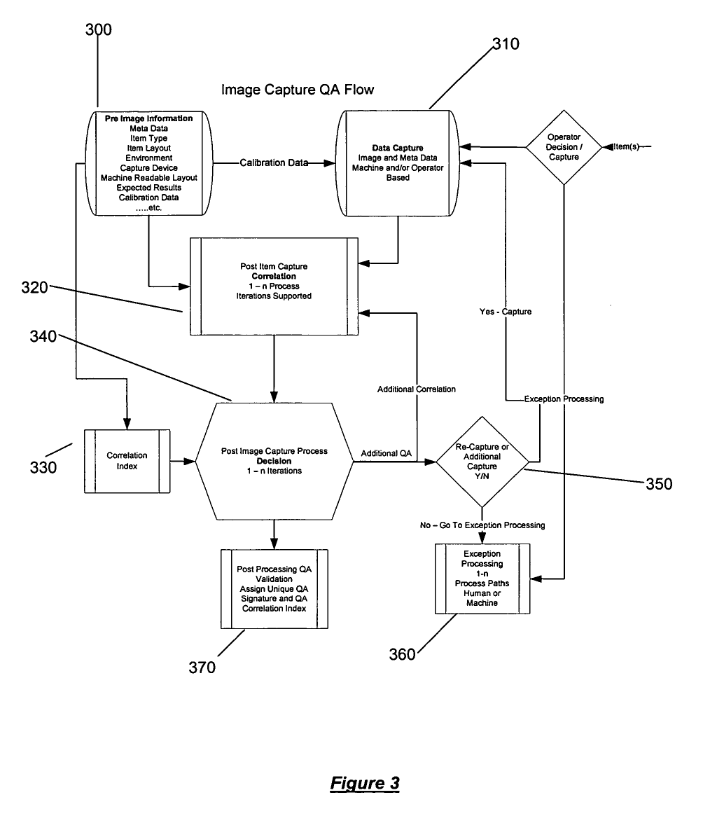

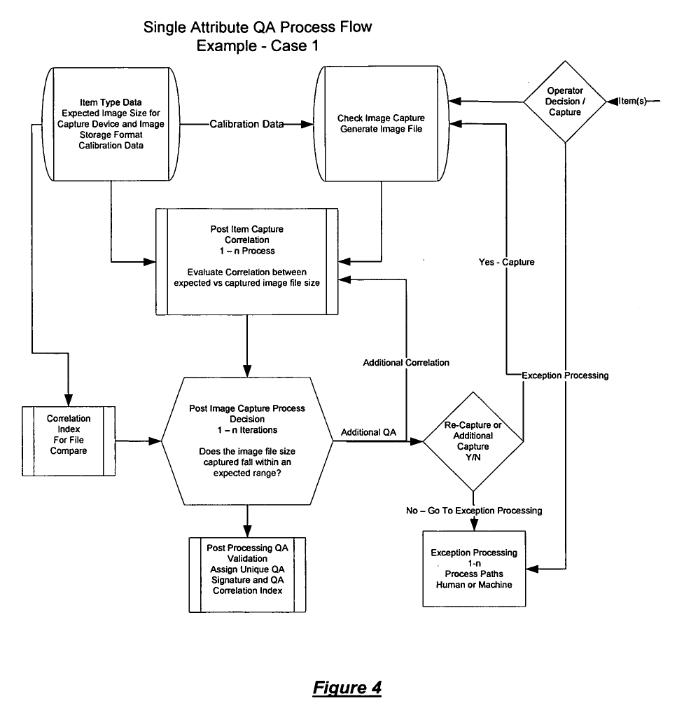

FIG. 1 traces the progression of a transaction in a check processing system. As is known, a payor or check writer 1 fills out a check 2a made payable to a payee 3. The check may be a paper instrument that the check writer fills out by hand or created electronically, printed and signed. In an embodiment, the check includes a MICR line that encodes the check number, the check writer's bank and the account at the bank upon which the check is drafted. The check writer determines the amount of the check and the payee, enters both on the check, may add additional information (such as what the payment was for), signs the check, and delivers it to the payee. As shown in the options of FIG. 1, delivery may be of the physical check to a bank of deposit or by an electronic transmission effected through a scan at the point of sale.

The payee 3 endorses the check 2b and presents it to a bank of first deposit or the payee's bank 4. In the present invention, the deposit bank 4 captures the check and related information, such as by a scan 5 to create an image of the front and back of the check and collects information such as the payee name, bank, payee's account number, the amount of the check and the MICR data. Typically, the MICR information representing payment information for debit and credit notices exchanged between payor and payee banks will comprise an electronic data record or file in the approximate range of about 500 bytes. The electronic image and associated data record file size will typically be approximately 25 KB or more. The captured information is checked for quality and if found insufficient, the transaction is flagged or routed for exception processing. After a scan 5 at whatever stage, the transaction data file and coordinated image and data file 5a, comprising the separate data file 10 and image plus data file 11 are separately manipulated and processed for settlement, payment and clearing in the paths shown as 12 and 13. For clearing, cash letters and bundles are prepared 14 and settlement processing proceeds in an image coordinated with data 16 follows data only 15 protocol. The cash letters and bundles are submitted into a clearing house 20 where aggregate funds transfers between and among financial institutions are calculated and ultimately paid. Because the small size data files may be transmitted more quickly than image files, the clearing house has a capability to timely notify financial institution participants of debit and credit obligations that will accrue upon actual receipt and processing of the imaged instruments upon conclusion of a periodic, or other, settlement, allowing an opportunity for an institution to rationally plan for cash flow needs in anticipation of settlement. After clearing, the checks (in image/IRD form) are returned to payor banks 22 where they are separately processed and associated with individual payor's accounts, and returned, as data and/or a complete or partial image, to the payor in or accompanying an account statement 25. The payee bank 21, receiving funds, will assign the funds and credit the respective individual payee 3.

The depository bank also captures other checks as defined herein, including all documents from a driver's license to a deposit slip that are also checked for quality and processed. The collected information may be electronically derived from the imaging and or converted by other methods, such as but not limited to, inputting the information by a human via a computer terminal to create an electronic representation of the information, teller generated, such as creating an electronic deposit slip based on the transaction that is input directly, outputted to a second device, such as a line printer and manually inputted into the imager, or hand written and scanned. Alternatively, the depository bank may transfer the paper check to an intermediary bank or to a payee bank which may gather the information, perform the imaging, and create the electronic data files.

As shown in an embodiment depicted in FIG. 2, a teller comprising an imager and optionally, means to input and view data, captures the check information and image, inputs additional information, provides image and data quality assurance and exception processing, provides security, provides check and account status, and allow for inquiries, look ups, or recalls of any check image file previously captured at that teller. The check image file and associated transaction information file and or the reintegrated image/data related to the paper check are all used in check processing.

Actions that are available after capture of the check image and associated transaction data related to the paper check are determined by status. For example, “On-us” checks are those written on a particular bank and cashed by or deposited into the same bank. These checks are handled and processed within that bank. “Not-on-us” (On-We or On-Other) checks are those that move between different banks and sometimes pass through additional bank(s) in any area of the network. In an embodiment, actions available at the teller include, but are not limited to, account look up, account status, validation of owner, availability of funds, determination of valid check number, confirmation that the check has not been presented, and actions specific to an account, such as, debiting, crediting, memo posting and the like. Actions that are available after capture of the check image and associated data gathered from the paper check are made available to any entity on the network via a unique services definition for that business relationship and are not limited to a single entity, such as the depository bank. The services definition for a business relationship can be one to one, one to many, many to many or any combination thereof.

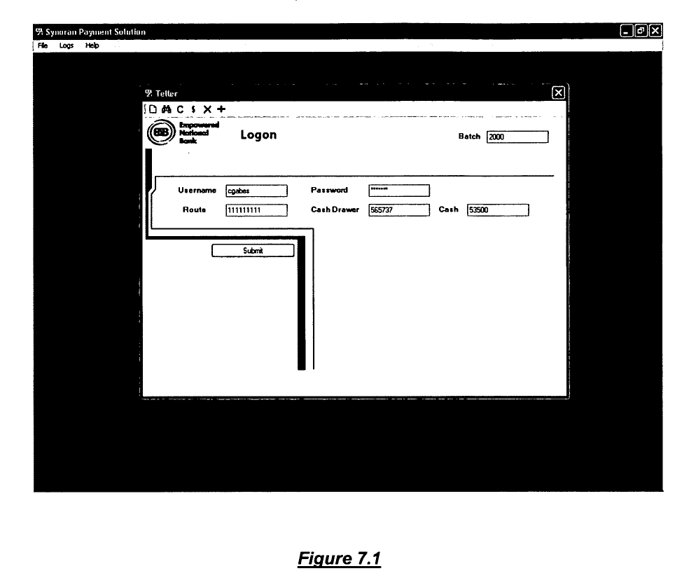

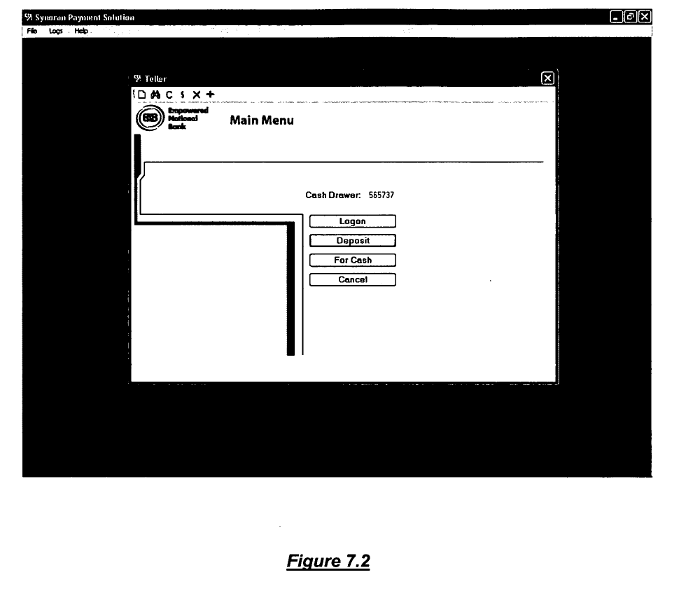

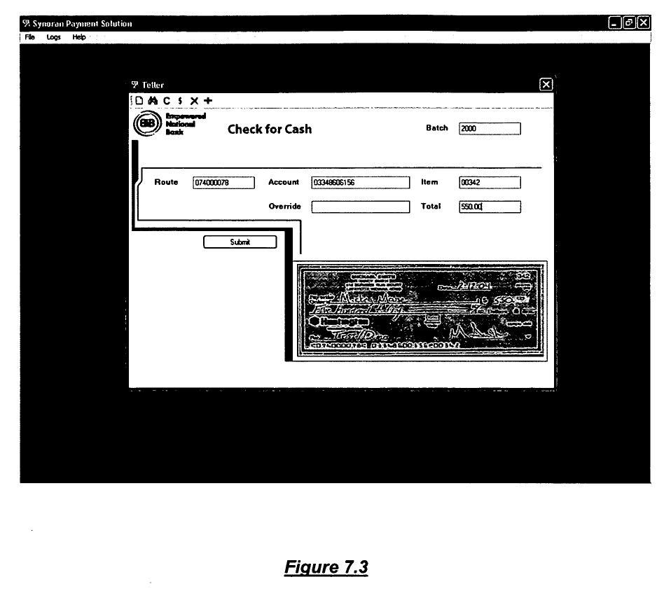

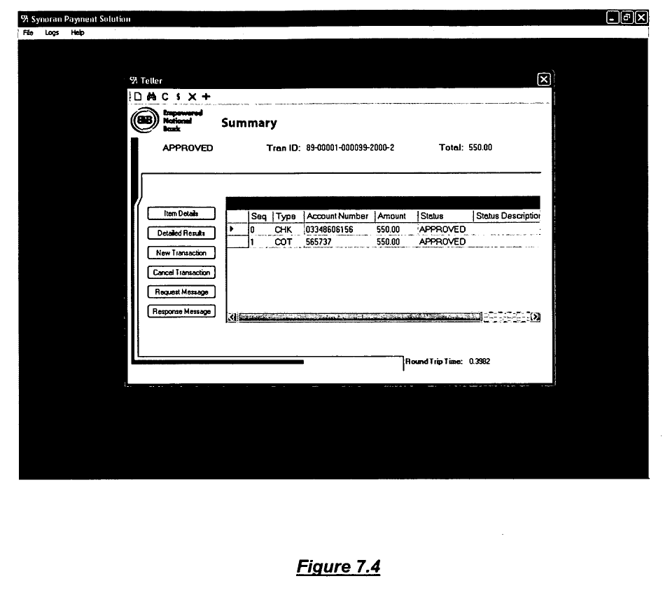

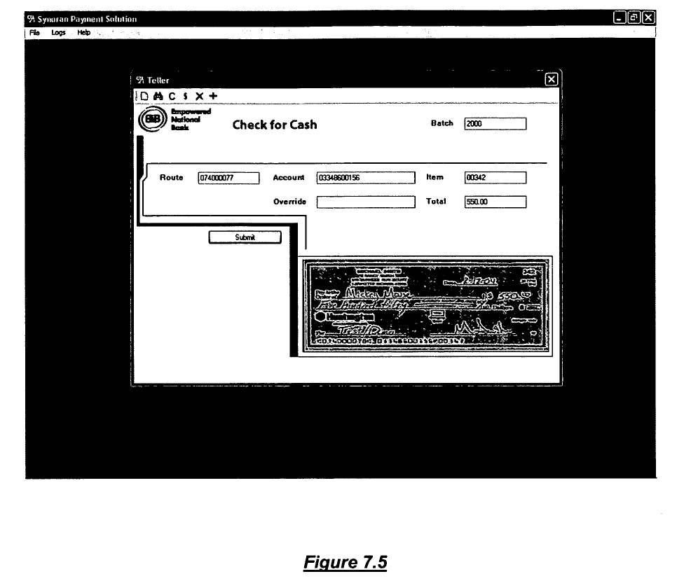

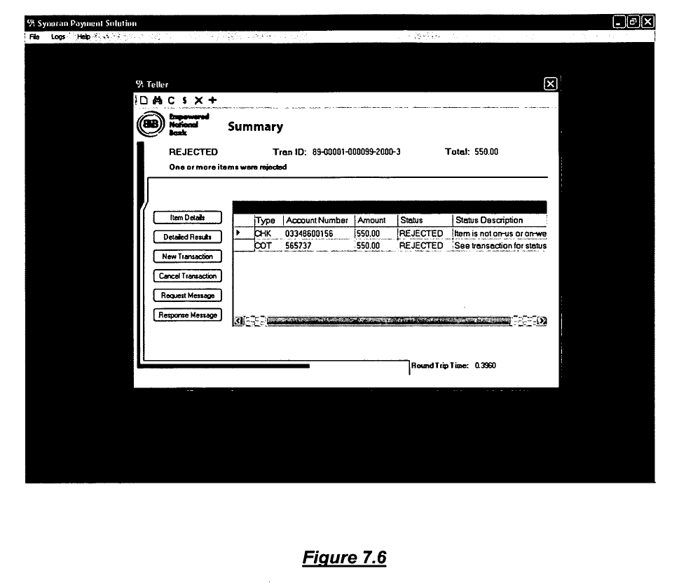

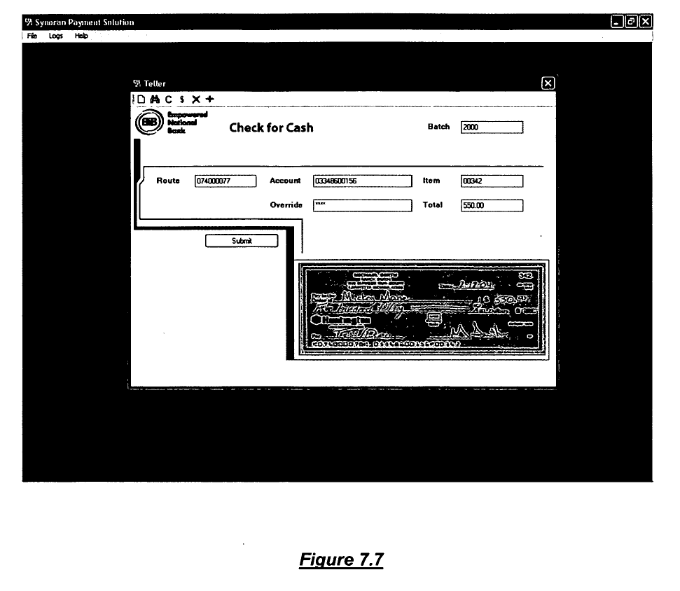

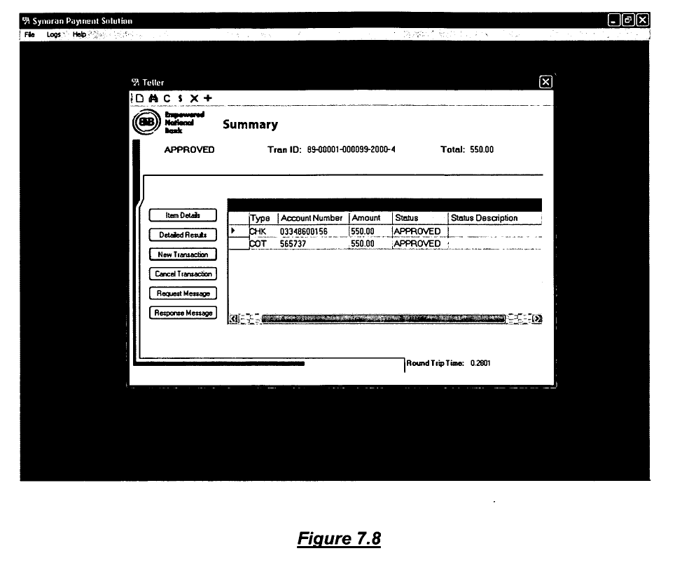

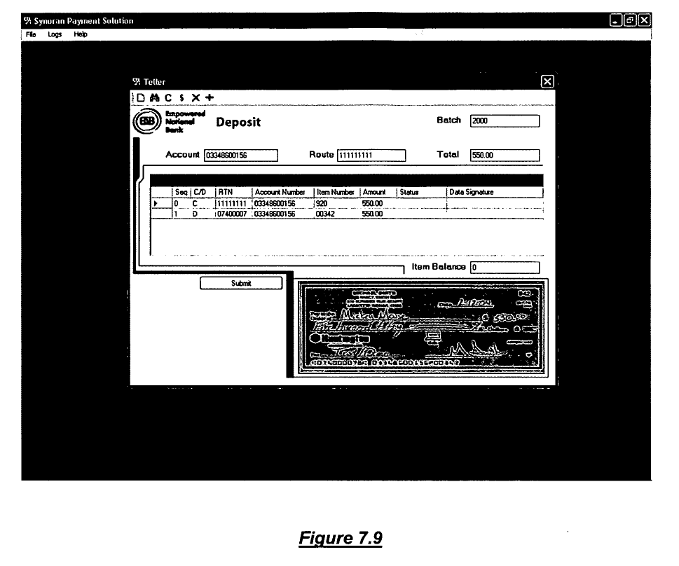

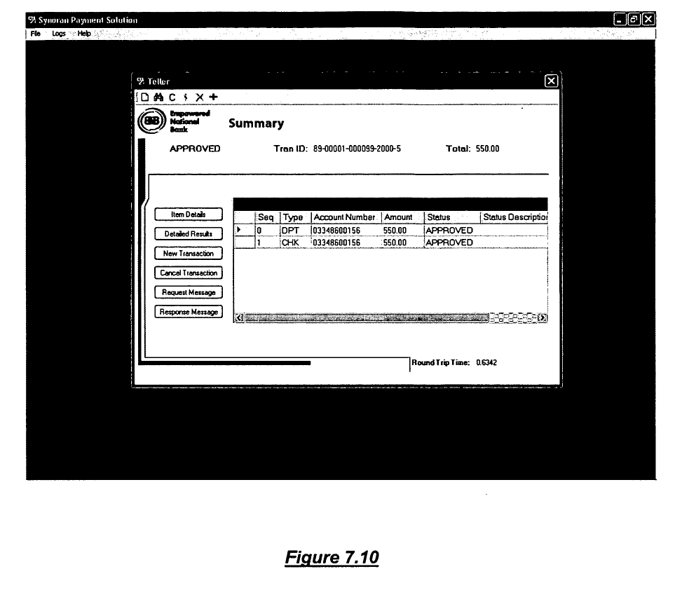

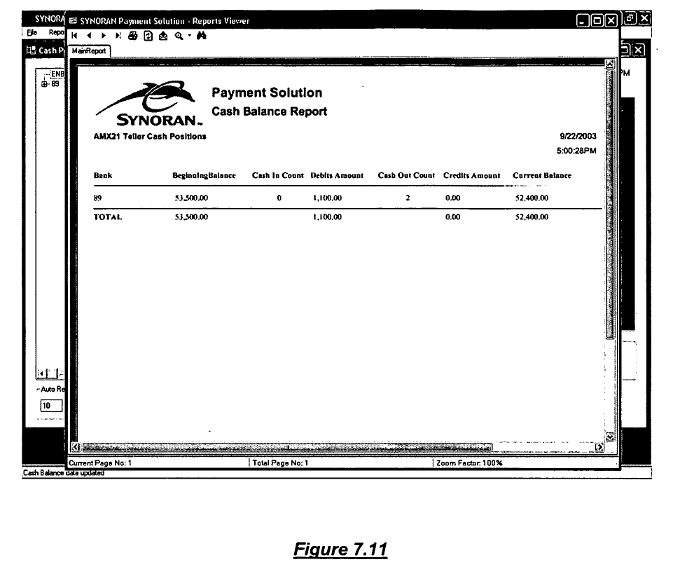

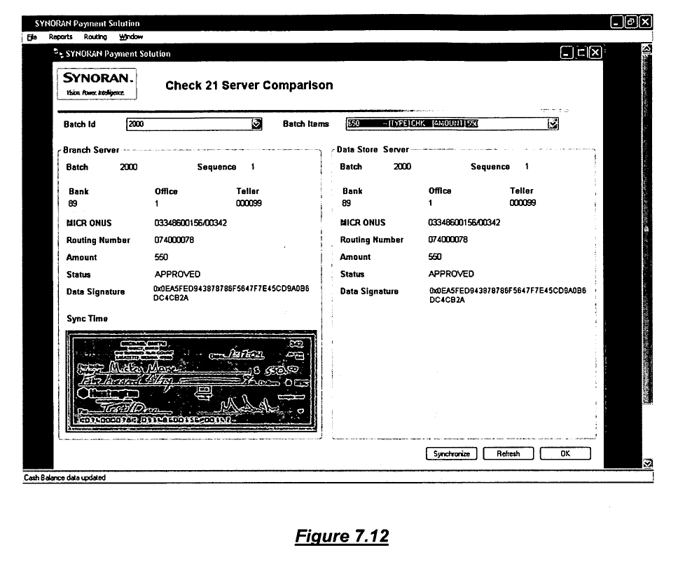

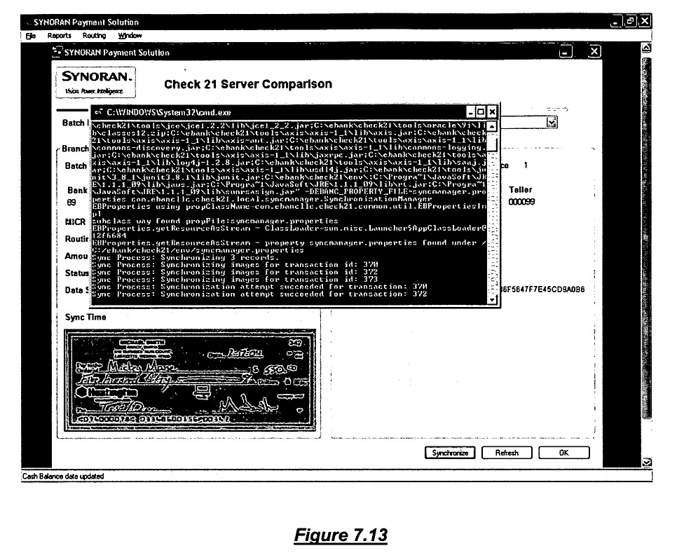

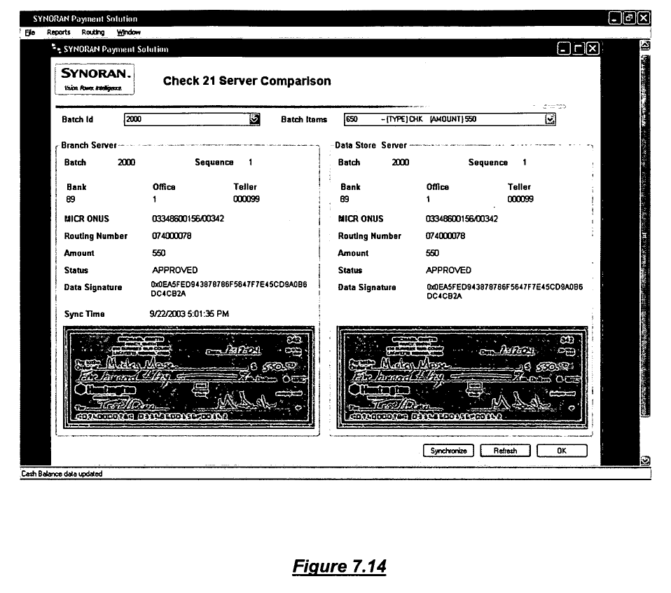

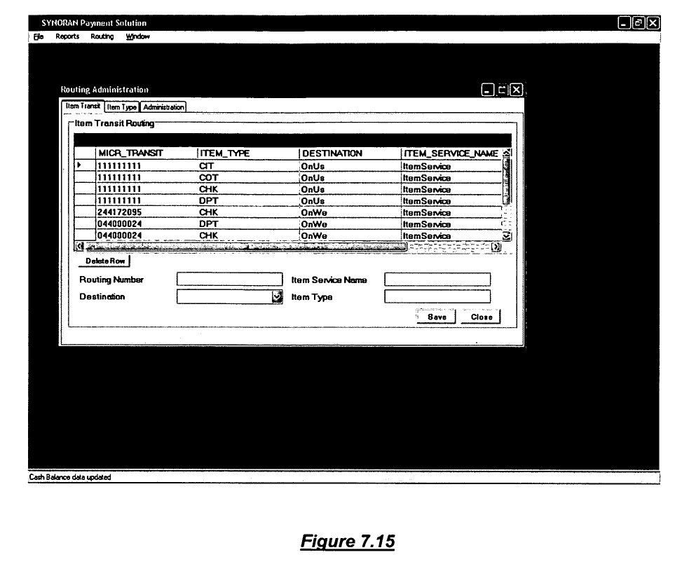

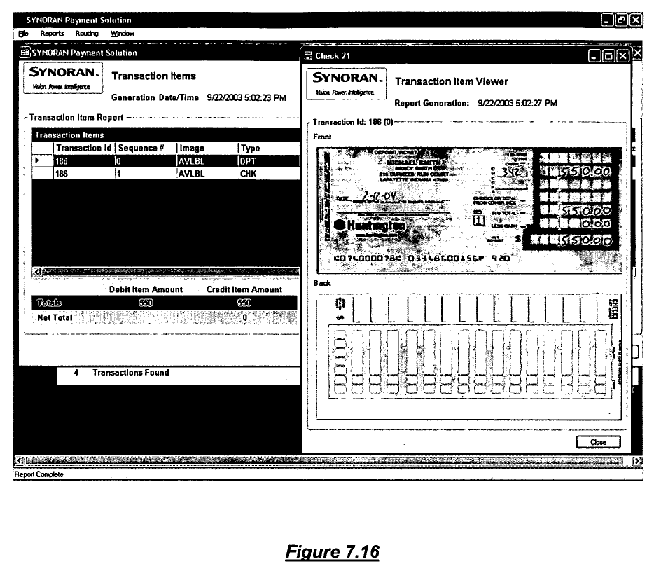

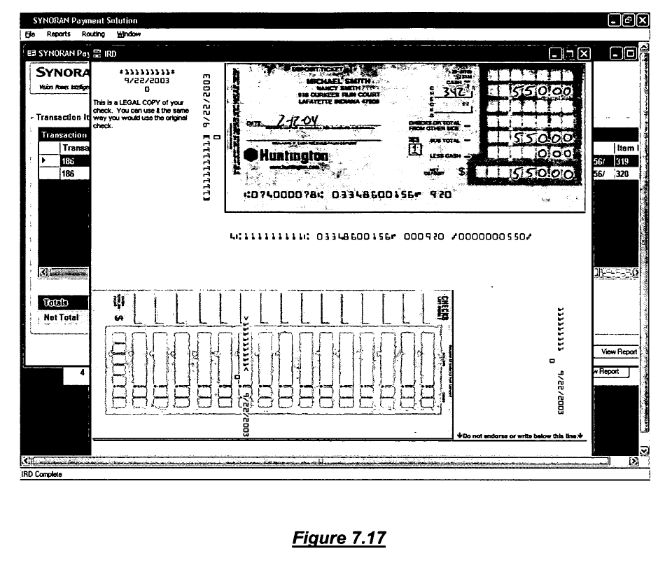

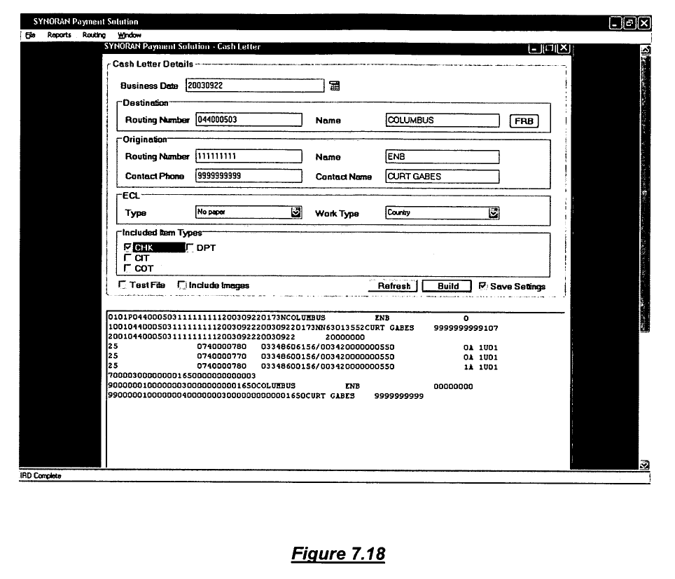

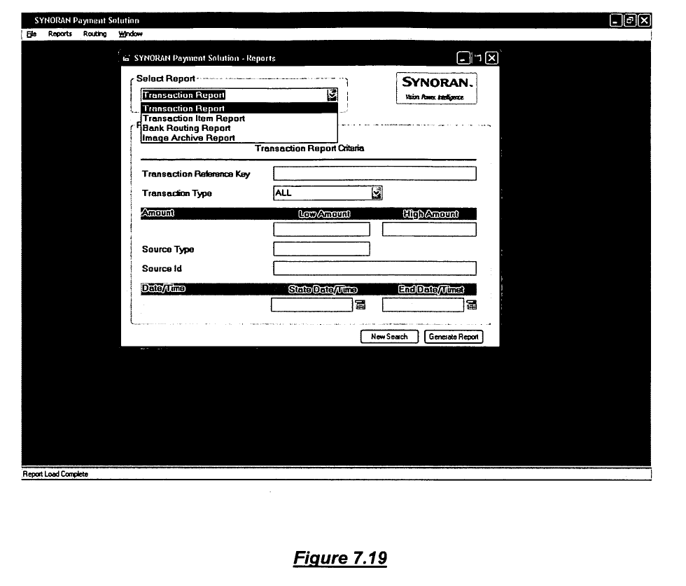

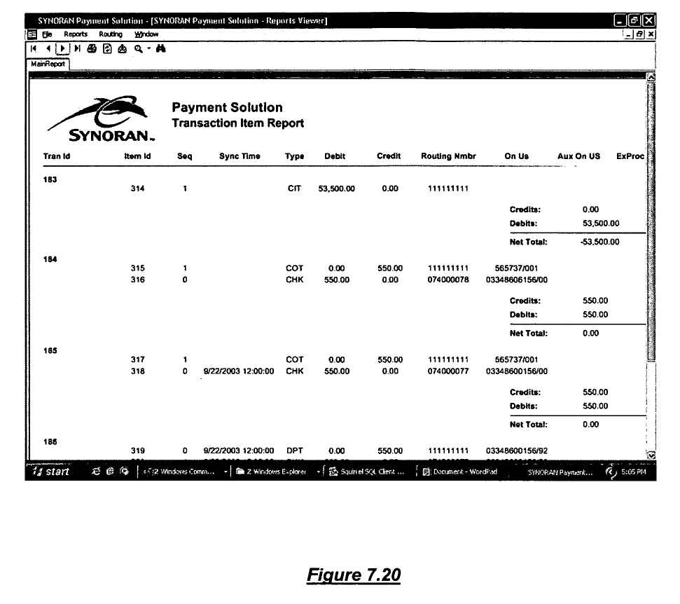

In an embodiment, as shown in FIG. 7.1 et seq., a teller signs on to the system, thereby allowing identification of the location of the presentment of the check. The sign-on may be electronically or human initiated. In an embodiment, the sign-on includes a username/password combination for security and defines the teller location by implementing a routing transit identifier, such as a routing transit number (RTN). An embodiment of the invention collects the individual teller ID, the branch ID, the bank ID, the terminal ID, the date and time, the batch and/or the sequence of the batch from the teller. Other information, including but not limited to starting data, such as the amount of cash on hand in teller cash drawer may be electronically derived or recorded manually.

A sign-on may include other authentication technology for security, such as biometrics, voice prints, etc. The system identifies each type of transaction performed at the teller, including cashing a check, making a cash deposit, and the like, and uses the teller's RTN to construct associated documents, such as cash-in and cash-out tickets, which can be timed to capture any period of time, from a given number of minutes to monthly or yearly intervals.

In an embodiment, the capture timing includes construction of daily cash-in/cash-out tickets. As shown in FIG. 7.1, the RTN, teller cash drawer identifier, and cash on hand at the teller, are parameters of the system. These parameters may be manually inputted or may be electronically derived. All transactions at the teller are recorded by the teller and or a local server and transmitted through the system. The transaction amounts are compared to the starting amount of cash on hand at the teller, manipulated and examined to allow a bank to monitor cash positions at a specific teller, for example, the amount of cash at any given time at a teller, including but not limited to the amount at a particular ATM, at a single merchant site, etc. The transactions may be merged with other teller transaction data to monitor cash positions of the bank as a whole or of any particular grouping within the organization.

In an embodiment, after teller sign-on is complete, a transaction screen is displayed on a computer monitor. The sign-on identifier is linked to all transactions and all items in a given transaction until a new period is defined, such as when a human teller or cashier signs off and a new person signs on. The period may also be electronically triggered and cover a group of sign-ons.

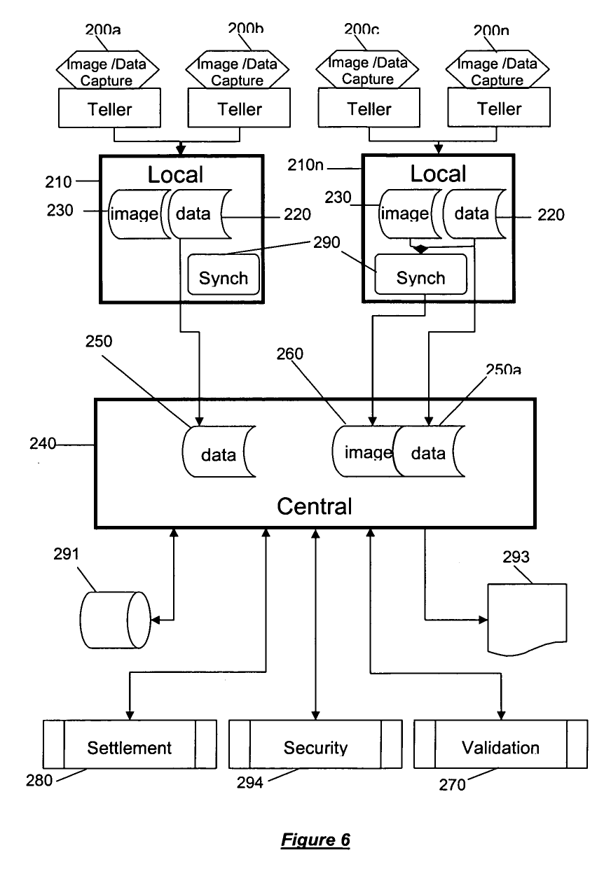

As shown in FIG. 6, a paper check is imaged at a teller 200a-200n and data is gathered related to the transaction. In an embodiment, the data includes the MICR line, which is derived from the scan, and the amount of the check, which may be electronically collected or manually inputted using a computer terminal. In an embodiment shown in FIG. 7.2, the teller accommodates different checks, such as a deposit of a check or a check presented for cash. The teller allows for transactions including multiple checks, such as depositing or cashing more than one check during a given transaction. The teller may cancel or override a previously entered transaction. All teller actions are logged and can be transmitted to a designated collection site locally, centrally or remotely located in real-time, or the action log may be stored for later transmission.

In an embodiment shown in FIG. 7.3, after imaging the image of the check appears on a terminal positioned at the teller. In an embodiment, a human teller electronically processes the transaction. Alternatively, the teller processes may be executed without human assistance. A teller may view and confirm captured image quality and the quality of data gathered from a paper check and/or pass a transaction or set of transactions to another process or destination point for exception handling and/or another quality assurance (QA) process that may be automated or manual. Captured images that do not meet image QA standards are flagged so that the paper check may be retained until quality can be confirmed, or, if unable to meet the standards, the paper check is processed using other means, such as conventional check processing.

FIG. 3 shows the basic steps of the QA process of the present invention for electronic check processing. FIG. 4 depicts the QA process using a single attribute to determine the standard of electronic check quality. The decisions and steps for quality during the collection of the image, transaction data related to the paper check and meta data vary based upon whether the collection is human based, machine based, or a combination. Acceptance standards are established to determine whether human, computer or human/computer collection meets the QA requirements, and checks (electronic or paper) that do not meet the established standards are flagged for exception processing. Acceptance standards may be determined by a single or iterative collection of the data and the like. The system allows for refinement and optimization of the QA process. When the acceptance standards have been met, the system provides a method to depict that the given level of QA has been met, such as a stamp of approval. Assurance is uniquely linked to the QA activity, which may be assessed at any of the steps in check processing, as well as to the paper check itself.

The present invention allows for assurance of image quality based on the intended use of the image. The present invention is adaptable to any set of standards and resulting QA processes required now or in the future for addressing the needs of check image quality assurance. The present invention establishes a set of parameters, terms and processes used to support check QA in an automated (machine), human or combined manner at user defined stages in the check processing chain that includes image and transaction QA.

The parameters, terms and processes are used for human, automated and combined QA as well as exception processing to address variations in the parameters in check capture and its components. The QA parameters, terms and processes are used to enhance fraud detection and to provide assurance to recipients that use an electronic version of the check or a paper check printed from the image that the electronic version meets given QA standards.

The invention provides image processing parameters for optimizing the cost and quality assurance of check image processing in support of the Check Truncation Act. The parameters are applicable to image capture and QA at the point of presentment (manned (human) or unmanned (machine)) through each step in check processing, including but not limited to bulk item capture and bulk image storage and retrieval systems and the like, at banks, including but not limited to back office processing centers, other locations in the processing chain, and the like. While the examples provided herein are applicable to check QA, the parameters are not limited to the examples and can be applied to other processes, such as fraud and exception processing and the like.

Electronic check quality is important in image capture and check truncation due to the need to assure the capture of a quality image, transaction data related to the paper check, and meta data before the paper check is destroyed. Electronic check QA is critical to the business value proposition for check truncation because the check image, which may include associated data, becomes the legal replacement for the paper check and must correlate to the related transaction for check processing. Retention of the paper check is necessary until electronic check quality is confirmed. The present invention's provision of assurance of quality of the electronic check allows paper check destruction early in the process which results in operational savings.

In an embodiment of the present invention, assurance that the result of the process of conversion to an electronic check as well as during processing of the electronic check is of the quality expected is determined by QA. QA of all aspects of electronic check processing is provided. In an embodiment, QA insures that a paper check recreated from the image file and or reintegrated image/data is sufficient to meet the needs of current paper check processing. One skilled in the art would know that the QA of the invention is not limited to current check processing, but rather may be applied to any imaging standards now existing or in the future.

The QA of the present invention compares variations in the captured electronic check data, which may include image and transaction data related to the paper check, to that of the paper document, expected data and or known data and then applies the variance to an established correlation index representing the acceptance variation for that application. Pre and post check capture conditions and a process for assessing various elements in comparisons are established. QA is implemented and refined based on the comparison of the variation between pre and post conditions to assure that the result is as expected to a given level of certainty. The QA process of the present invention is not limited to the examples and embodiments defining a given set of definitions and pre and post conditions that support the QA process around check image quality assurance. One or more existing, or one or more new conditions determined through cost, quality, risk, speed and the like may be used to establish a QA process acceptable to any bank, other institution or given user.

Currently in the area of paper and image based payments, over 200 standards have been developed around processing. The standards establish baseline formats and layout as well as suggested best practices. Current areas covered include: core standards around paper requirements, MICR requirements, optical requirements, and image requirements. Application standards have been developed for checks, such as traditional checks, deposit tickets, internal documents, image replacement documents and the like. Definitions have been established using X9B standards. The base information contained in these standards (see Technical Guideline: Organization for Standards for Paper-based and Image-based Payments, American National Standard for Financial Services Secretariat: Accredited Standards Committee X9, Inc., Approved Mar. 1, 2003, hereby incorporated by reference) may also be used to establish expected conditions (check meta data) in support of the QA process of the present invention. Due to the many variations in checks, imagers and operational processing needs, a user may utilize one or more parameters, terms and or processes to define a QA index and/or iterations that will be utilized to meet that user's specific needs.

Referring back to FIG. 3, the flow of QA for electronic check capture comprises: 1) precapture of information, 2) image and data collection, 3) post capture correlation, and 4) post capture decision processes. Each process is now discussed.

In an embodiment of the invention, the image capture device is initially calibrated 300 to assure that the device is operating as intended and is not introducing errors that are not accounted for in the QA process. Prior to the capture, the operator, which may be human and or machine, inputs information specific to the activity. Information collected includes, but is not limited to, meta data about the process, devices, and checks, and includes determining established data about the check (such as item type), capture device, process, the capture environment, expected results and the like.

Established data related to information contained on the paper check is created relative to an identification of the type of item (such as a check, deposit slip, and the like) the layout of the information on the check relative to item type, MICR string and location of the string, the expected size of the image file, Courtesy Amount Recognition (CAR) and Legal Amount Recognition (LAR) parameters, calibration items, the layout for Optical Character Recognition (OCR) and Intelligent Character Recognition (ICR) processing, and the like.

Established data related to the capture device and process is created or derived from information contained in the capture device, such as capture device identification, Capture Device Image Deviation (CDID), Signal to Noise Ratio (SNR), Peak Signal to Noise Ratio (PSNR) Modulation Transfer Function (MTF); Mean Squared Error (MSE), Frequency Distribution, Root Mean Squared Error (RMSE), Mean Absolute Error (MAE), the image file size, Capture Device Quality Index (CDQI), the Capture Device Image Resolution (CDIR), the Capture Device Image Format (CDIF), and the like.

Established data that may influence the capture process related to the capture environment is determined, including but not limited to transmission speed, such as high speed or teller line, teller type, such as point of sale terminal, ATM, etc., date, time, location, device, process, image storage format, check capture calibration data, and the like.

Established data related to the expected results for a given Image Type Identification (ITID), CDID, and environment is created, including expected Image Quality Index (IQI), expected Image Similarity Index (ISI), expected Image Capture Format (ICF), and expected Image Storage Format (ISF) with file attributes.

Other information that is precaptured includes information related to the user and or machine assigned data for the check and process, such as check quality value and information related to derived data based on one or more than one relationship between and or among the established data. The capture device may optionally automatically collect all or some of the information.

The QA process of the present invention supports the establishment of expected results based on preconditions. The preconditions may be real time as part of the capture process or determined as the result of statistical models based on a group of historical data and can be used to train a neuro network or fuzzy logic algorithm resulting in a correlation index. Preconditions may also include a mix of real time results and historical results used to establish what is expected with the item in order to assess QA based on correlation. Preconditions are not limited to pre-capture information collected as part of capture.

In an embodiment, the system confirms the calibration to establish data about the performance of the capture device for each check as related to type and to establish test processes and patterns to assure that the device is operating within acceptable guidelines; therefore the check type to be captured is pre-established in the system and the behavior of the capture device is known with respect to capturing the check. Optionally, established data from the calibration confirmation is stored for future reference and verification.

To perform the collection of data by a capture device 310, the paper check is exposed to the device to image the check. A machine scan of the paper check is performed to collect and determine data such as MICR data (RTN, account number, check number, amount, etc.), OCR/ICR derived data, image processing derived variables or metrics, including IQI and ISI and the file size and the check size. The captured image may be segmented by a grid and QA performed on one or more than one element and or subset of elements identified in one or more segment of the grid. Through this process, critical data may be identified and non-critical segments of the image eliminated from additional QA processing The operator, which can be a human or can be a computer applied method, optionally inputs meta data such as the Image Quality Value (IQV), the amount, the payee, the payer, the check number, and the like. IQV may be automated and in itself may be part of the QA process and may be machine derived or human based depending on the capture needs. Derived data (data calculated based on known and information collected) and configuration data (known data about the device, process, check type, etc.) are also determined. Optionally, calibration data, such as established data, resulting from the calibration process is used in the QA process.

After imaging, the image file is compared to information, such as expected image data 320, including but not limited to expected file size. Any image that is outside of an expected range is reimaged and or flagged for exception processing.

A Quality Assurance Correlation Index (QACI) or Correlation Index 330 is derived from a mix of historical data and elements of the precapture process. The Correlation Index itself or in combination with other values is used to establish a range of values for QA acceptance and/or QA process and exception flow.

Where the image file falls within a predetermined range of acceptable expected file sizes, the image file is further tested based on established standards 340. Images undergo the QA decision process to produce a result representing the correlation of the image to a previously defined Correlation Index. Indexes explained below are used alone or in combination to determine a Quality Assurance Correlation Value (QACV). QACV in combination with the Correlation Index definition establishes the standard by which all captured images are valued for QA. Images that do not meet the QACV are flagged for exception processing 360, or alternatively, undergo additional imaging and or manual or machine based QA steps or QA completion 350 prior to finally flagging for paper processing or approval of the image.

Images that meet the parameters set for image quality are validated 370. A QA digital signature and or watermark unique to the paper check, process, capture environment, and or processor is generated and associated with the image file. The QACV or a derivative is used as the QA stamp of acceptance and may be encoded in the digital signature along with other unique data.

The set of conditions or process artifacts for various points in the QA process determine the level of image quality assurance. The QA element of the invention may include one or more of the parameters listed herein or others establishes in the future, and the required correlation between and among parameters.

The following table lists examples of data sets used for QA correlation.

TABLE I

| Data Items | | | |
|---|---|---|---|
| or | | Pre Capture | QA Sample Correlation |
| Attributes | Capture Artifact(s) | Artifact(s) | Item(s) |
| Check # | Data in MICR Scan | Expected MICR | Correlation between any of |
| | Operator Keyed | data | the 3 identified Capture |
| | Data | Location of check # | Artifacts. |
| | OCR on Check | for OCR processing | May leverage layout to |
| | layout for check # | | support OCR on Check # |
| MICR Data | MICR scan line | Expected MICR | 1. Was the data captured in |
| | | data | the sequence expected? |
| | | | 2. Does the data captured |
| | | | correlate to the data |
| | | | types expected (Valid |
| | | | RTN, etc)? |
| CAR/LAR | Courtesy Amount | Location of | 1. Is there a CAR or LAR |
| | Recognition | CAR/LAR data in | value on the captured |
| | amount | check layout | check? |
| | Legal Amount | | 2. Does the CAR and LAR |
| | Recognition | | amount match? |
| | Operator keyed | | 3. Does the CAR/LAR |
| | amount | | match the operator keyed |
| | | | or observed amount? |
| Item | Horizontal and | Expected | 1. Does the captured data |
| dimensions | vertical dimensions | dimensions (h × v) | match the expected |
| | of item | Expected aspect | dimensions? |
| | Item aspect ratio | ratio | 2. Does the captured aspect |
| | | | ration match the |
| | | | expected or within a |
| | | | range of expected? |
| Double scan | Duplicate image | Expected Image | Does the captured image |
| compare | scans | Similarity Index (ISI) | compare data match the |
| | | | expected ISI for the |
| | | | capture device and the |
| | | | ITID tested? |
| Test Check | Test pattern image | Stored test pattern | Does the captured test |
| or Pattern | or test item image | and expected | pattern match or correlate |
| Scan | | Capture Device | to the stored test pattern. |
| | | Image Deviation | Is this correlation as |
| | | (CDID) | expected? |
| Image | File size attribute of | Expected file size | Does the capture file size |
| Storage File | captured item | for Image Type ID | attribute match or fall |
| Size | | (ITID), Capture | within an expected |
| | | Device ID CDID, | range? |
| | | and Image Storage | |
| | | Format (ISF) | |
| Image | Captured Image | Expected Image | Does the captured IQI match |
| Quality Index | Quality Index | Quality index for | or fall within an expected |
| (may be | (Processing | Image Type ID | range? |
| many of | algorithms: MSE, | (ITID), Capture | |
| these based | PSNR, MAE, etc) | Device ID (CDID), | |
| on various | | and Image Storage | |
| image | | Format (ISF) | |
| processing | | | |
| algorithms | | | |
| Signature | Digital signature | There must be a | 1. Is there a signature on |
| Verification | | signature on file | the captured check? May |
| | | | be machine or human |
| | | | based. |
| | | | 2. Does this signature |
| | | | match the signature on |
| | | | file? May be machine or |
| | | | human based |

Any of the data items in the above table can be combined and weighted to establish a QA Correlation Index that is unique to the process, check type, capture environment, check processing environment, step in check processing environment, and/or capture device. The Correlation Index is then used to assess the quality of a specific QA correlation value. Using a Correlation Index provides for a consistent method to share QA information across a family of users. Additional items exist that could be used for QA purposes. The final process is determined by the user or group of users.

The QA terms used herein and discussed below are provided as a method to establish and qualify a family of QA processes and workflows for electronic check processing quality assurance. The terms are defined as they relate to check capture QA, but as one skilled in the art would readily realize, the terms may be used for any QA process where image and image meta data are captured, derived or leveraged for processing and a need exists for QA for the processing.

Item Quality Value (IQV) is a value or classification that establishes the quality of the paper check that is to be captured. IQV may also include a range that correlates to a set of parameters that establishes a total automated QA index where related parameters apply. IQV may include a range or ranges where exception processing is triggered that may include human assessment and/or additional machine automated QA. IQV is a value used to establish the QA system and/or QA process for a range or specific value of the check. IQV may be as simple as human inspection where the operator makes a decision to image the item or forward it for exception processing.

An input variable to the process is used to establish a base process for that a given IQV or IQV range. For example, the variable may be “it can be captured” or “it can not be captured.” After the decision is made that the paper check cannot be captured, the paper check follows one or more defined exception handling paths based on the IQV and/or other parameters.

Item Type Identifier (ITID) establishes the characteristics of a check type or group of check types such as but not limited to retail versus commercial check, cash in/out tickets and the like, and their associated data, layout, metadata and expected data. The ITID may be automatically determined by the capture device, input by the operator, or otherwise computed. ITID is used to differentiate check types and as a result supports the definition of check type specific or unique QA processes and decision flows based on data in the ITID as well as comparison of expected versus actual data.

Specific data may include, but are not limited to check size, MICR line encoding patterns, layout, and additional item artifacts such as check number and the location of specific check characteristics on the paper check layout. Artifacts can be used to establish OCR patterns and other image processing techniques for analysis and quality assurance. Additional processing techniques include correlation between OCR/ICR read and MICR read data, correlation between CAR (Courtesy Amount Recognition)/LAR (Legal Amount Recognition) values and those encoded in the check or keyed in by a user/operator, and the like. The ITID may include a data definition about the image and transaction and the definition of meta data to be used in check capture, QA processing and or fraud detection. Based on a given check type, parameters specific to the QA process to be applied are established and evaluated as part of the QA process.

As an example, a range for established QA patterns or a check type profile is retrieved from a stored location and compared to calculated data based on a scan, analysis, and or meta data for a check. The ability to establish various process flows based on the ITID provides for the flexibility to balance cost, performance, and risk in the QA process. As a further example, a high value check may follow a more rigid QA path than one of low value. The invention optimizes QA process flow to the risk profile or exposure of a given check and/or collection process. QA is supported based on value and/or risk and results in a more cost effective solution than a one QA method meets all needs approach, allowing for the optimization of cost versus risk for various processing and QA scenarios.

The process flow establishes a check type template that defines data or data ranges for that check as well as a QA decision tree or workflow for that check. The decision tree may also include data about the QA process that is necessary to account for errors in the capture processing chain. Data ranges are compared to actual data to assist in the QA flow and/or decision process. The comparison includes a range for meta data correlation or other correlation information for the check that is used in assessing QA.

Image Quality Index (IQI): is a value or range of values that are generated from processing the image in terms of the expected resolution and quality. Standard image processing metrics used in IQI may include but are not limited to Mean Squared Error (MSE), Peak Signal to Noise Ratio (PSNR), Frequency Distribution, Root Mean Squared Error (RMSE), Mean Absolute Error (MAE), and Signal to Noise (SNR). Image variables that account for image distortion may also be included, such as values for loss of correlation, luminance distortion, contrast distortion and/or relationships between variables, and the like.

IQI is a derived value used as a QA qualifier for decision making. IQI establishes a value for the captured image that correlates back to the check type and the capture device's ability to capture data consistently and accurately. Correlation to expected results or a range of results is the basis for decision making using only the IQI.

Capture Device Identifier (CDI) establishes the characteristics of a specific capture device or classification of devices and associated environments. The CDI is automatically determined by the capture device, pre-configured, and or input by the operator. CDI differentiates capture devices and environments and supports the definition of the capture device specific or unique QA processes and decision flows to leverage well known pre capture data for use in the QA process. CDI may include the initialization of complex decisioning and learning computer models that leverage a neuro network and/or fuzzy logic methods.

CDI optionally includes a data definition about the capture device and environment, a definition of meta data about both, and the like. The CDI is used in post processing to support QA decision making and fraud detection. Based on a given CDI, parameters specific to the QA process to be applied are established and evaluated as part of the QA process. As an example, a range of QA patterns or device profile retrieved from a stored location and compared to calculated data based on a scan and meta data for a specific CDI. The ability to establish various process flows based on the CDI provides for the flexibility to balance cost, performance, and risk in the QA process and allows the QA process to be customer tailored to the specific processing environment.

The CDI establishes a unique capture device and environment configuration that defines data or data ranges unique to that situation in support of the QA process. The CDI is used to configure and traverse a QA decision tree or workflow for that capture device. CDI optionally may include data about the QA process that is necessary to account for errors in the capture processing chain as well as capture device and environment calibration. In the QA flow and/or decision process, data ranges are compared to actual data, which may include a range for meta data correlation and other correlation information for the CDI.

Capture Device Quality Index (CDQI) is a value or range of values that represent the capture devices ability to accurately capture an image. The index may include one or more specifications such as pixel resolution, pixel depth, color depth, pixel noise, device system signal to noise ratio, pixel correlation noise, the device's Modulation Transfer Function (MTF) and the like.

CDQI is used to represent the error that the capture device may or may not inject into the decision process based on its ability to capture the check. The CDQI affects the IQI and ISI and accounts for elements of capture device error in the decision making process.

Image Similarity Index (ISI) is a value or range of values that represent the correlation quality between two images of the same check by the same or similar device. ISI establishes a level of correlation or deviation between two separate captures of the same check or between the capture of two substantially similar checks. ISI includes values as stated above that are inclusive in the Image Quality Index but establishes a quantified value for the variation between two images of the same check. ISI is optionally used to establish a calibrating range for test images or patterns (e.g. digital watermarks) that may be included in base lining, calibrating, or verifying the proper operation of the capture device against a known test check or other data.

ISI is a derived value used for decision making and capture device QA that represents the correlation between two identical images as compared to expected data contained in the ITI. Where the ISI indicates a large deviation, the capture device may be malfunctioning or the paper check may be of low quality. ISI is also used to compare a calibration scan to a known scan to validate that the capture device is operating within acceptable parameters. A user establishes a value that leverages the ISI for any specific combination of check type or image capture device variables (IQV, ITI, etc.).

Capture Device Image Deviation (CDID) is a value or mathematical equation that represents the ability of the capture device to accurately capture consistent images. One example is double scanning the same paper check and then evaluating the correlation between the resulting images. The correlation between two scans of the same check establishes the error that a device may introduce into the image as a function of its performance characteristics and the capture environment, which is used as an error factor accounted for in the ISI calculation so that the error introduced by the capture device can be accounted for in the QA process.

Image Device Capture Resolution (IDCR) is the resolution of the image capture device in relation to the paper check. IDCR includes horizontal and vertical pixel resolution and color or image depth for the device as it pertains to the image being processed (pixels per linear dimension and or bits per pixel). IDCR optionally includes performance parameters for the device such as pixel to pixel SNR, overall system noise, error factors, and the like as they relate to the capture device and resolution. IDCR is used to establish correlation between expected results based on a given ITI and IQV for a check.

Image Capture Format (ICF) is the image file format used for image capture and manipulation. ICF is specific to the capture device and typically not available to any outside system. The final output from the image capture device is the same as the image storage format and optionally includes meta data about the image, capture device, operating environment and the like.

ICF is accounted for in the QA process where the ISF is different than the ICF. Where ICF differs, it is used to determine the error that may or may not be introduced into the QA process by the conversion from ICF to ISF. ICF is significant in image compression or file conversion from ICF to ISF.

Image Storage Format (ISF) (with or without compression) is the image file format used for image storage, transmission, and manipulation. Many digital formats, such as TIF, GIF, JPEG and the like are available. For image quality, two terms of the image capture format and the image storage format: lossless and lossy must be determined. Lossless maintains that there is no loss of image quality as a result of image storage and retrieval. Lossy maintains that there is a loss of image quality as a result of some form of image reduction that is done to put the image in the storage format. Where there is no loss or if the original image is completely recoverable from the storage format it is a lossless format or process. Where the image cannot be completely recovered from the storage format it is considered a lossy format (JPEG formats utilizes a form of lossy image compression). The ISF may optionally include meta data about the image, transaction, device, and/or capture environment used as in the QA process.

ISF may need to be considered in lossy compression and in conversion from ICF to ISF to calculate the error introduced into the system by file conversion and/or compression. ISF is optionally used to identify specific meta data about a given check type.

Meta Data Correlation Index (MDCI) is a derived range of values based on the correlation of metadata and actual data about an item captured. Many parameters, such as but not limited to IQV, ITI, IQI, CDQI, ISI, CDID, IDCR, ICF, ISF, and IDCR are inclusive to MDCI. Meta data includes information about image size, resolution, spatial variation, OCR data, CAR and LAR correlation, signature correlation, MICR data to OCR data, storage format characteristics, and the like. Actual data includes keyed transaction amount, MICR data, check layout characteristics, and or other data encoded on the check, storage format, capture format, or related transaction and processed as part of the image capture processing chain.

MDCI establishes a scale for assessing a Meta Data Correlation Value for a specific check types or family of check types. MDCI is an output parameter that, by itself or in combination with other values, is used to establish a range of values for QA acceptance and/or QA process and exception flow. MDCI is derived from a mix of historical data and the parameters listed above.

Meta Data Correlation Value (MDCV) is a derived value that establishes the correlation of a check to a previously defined Correlation Index. MDCV is specific to a check type or family of check types and establishes a specific degree of quality in relation to the index. MDCI is used to establish a definitive value for QA against a previously defined index.

Quality Assurance Correlation Index (QACI) is similar to the MDCI but is a higher level of derived range of values. QACI encompasses the overall QA process and establishes and overall QA Correlation Range for that QA process. QACI is a superset of the MDCI that accounts for variations in the check type, capture environment, capture device, data correlation, storage format, etc.

QACI establishes a scale for assessing a QACV for a specific QA process around check capture processing. QACI is an output parameter that, by itself or in combination with other values establishes a range of values for QA acceptance and/or QA process and exception flow. QACI is derived from a mix of historical data and can encompasses anywhere from one to all elements of the capture and QA process beyond that of just the check.

Quality Assurance Correlation Value (QACV) is a derived value that establishes the correlation of a check to a previously defined Correlation Index. QACV is specific to the check type and the associated process, environment, capture device or the like, or a define range or group of these elements. QACV establishes a specific degree of quality in relation to the index and establishes a definitive value for QA against a previously defined index for the overall image quality assurance process. QACV in combination with the index definition establishes a standard which all captured checks are valued in terms of a QA process. QACV or a derivative is used as the QA stamp of acceptance for a user community.

To further illustrate the QA of the invention, the following examples are provided.

### EXAMPLE I

### An Imaging QA Process without Operator Input

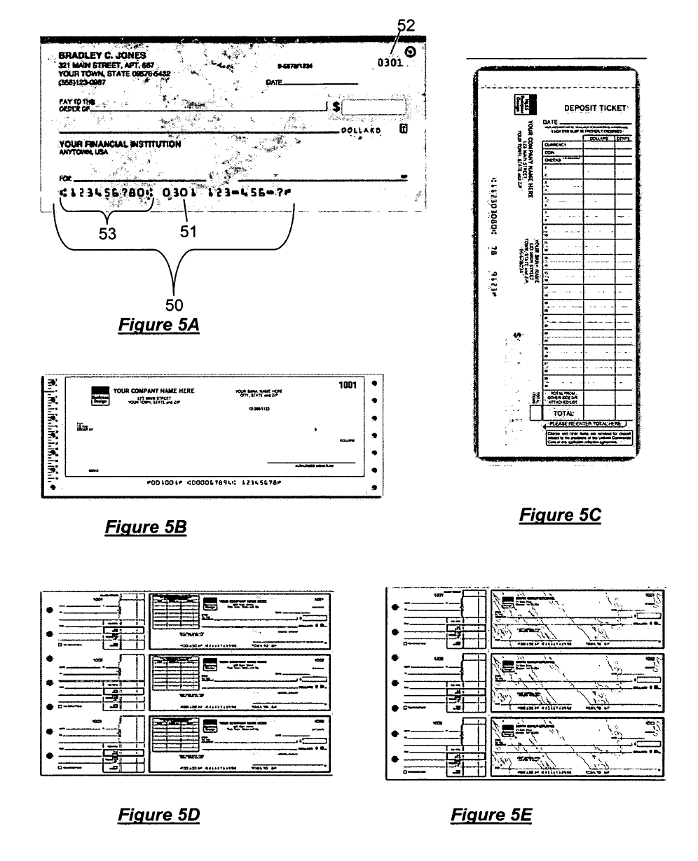

1. A paper check, as illustrated in FIG. 5A, is scanned and the MICR line 50 is converted to digital information. The MICR line 50 includes the number of the check 51.

2. An OCR/ICR read of the check number 52, is performed based on the scan.

3. The OCR/ICR derived check number 52 is compared to the digitalized MICR check number 51.

4. Where the OCR/ICR derived check number 52 equals the digitalized MICR check number 51, the following assumptions are established:
a. the paper check was of sufficient quality to support accurate machine based MICR reading and image capture;
b. the MICR reader was working correctly; and
c. the digital image was of sufficient quality at the check number 52 to support accurate OCR of the check number 52.

5. The assumptions establish the level of check capture QA and condition of the paper check QA.

6. Exception processing is established to address instances where the OCR derived check number 52 is not equal to the digitalized MICR check number 51. Exception processing may include additional tests to determine the problem area prior to flagging for paper handling. Many additional parameters can be added to this QA process. The current invention establishes a process by which 1-n iterations may be made to arrive at the level of QA needed. Each iteration may depend on one or more parameters or sets of parameters, as is the case for each subsequent iteration.

### EXAMPLE II

### An Imaging QA Process Facilitated by a Human Operator

The check is imaged and the MICR line 50 is converted to digital information. The MICR line includes the account number 53.

1. The operator keys the account number 53 into a computer created file that is specific to the scanned instrument.

2. The data keyed in by the operator is compared to the digitalized MICR line including the account number 53.

3. Where the data keyed in by the operator equals the digitalized MICR account number 53, the following assumptions are established:
a. the paper check was of sufficient quality to support accurate machine based MICR reading; and
b. the operator accurately determined and input the account number from the check. This represents a piece of meta data about the check.

4. The assumptions establish the level of check capture QA and the human ability to decipher and correctly input an account number QA.

5. Exception processing is established to address instances where the operator perceived and inputted account number is not equal to the digitalized MICR account number 53. Exception processing may include additional tests to determine the problem area prior to flagging the check for paper treatment.

### EXAMPLE III

### QA where an Operator Inputs the Check Number

1. The operator visually perceives and inputs the check number 52 into a computer file for that instrument.

2. The capture device images the item.

3. An OCR read of the check number 52 is performed.

4. The data keyed in by the operator is compared to the OCR check number 52 derived data.

5. Where the data keyed in by the operator equals the OCR check number 52 derived data, the following assumptions are established:
c. the paper check was of sufficient quality to enable the operator to perceive the check number;
d. the operator accurately keyed in the check number; and
e. the digital image was of sufficient quality in the area of the check number 52 to support accurate OCR of the check number.

6. The assumptions establish the level of check capture QA and the human ability to decipher and correctly input a check number QA.

7. Exception processing is established to address instances where the operator perceived and inputted check number is not equal to the OCR derived check number 52. Exception processing may include additional tests to determine the problem area prior to flagging the check for paper treatment.

### EXAMPLE IV

### A QA Process where a Capture Device Images a Check and the Image is Compared to Stored Expected Results

1. The device images the paper check, converts the image to a given format and stores it in a computer file (e.g., Image Storage Format).

2. A machine process compares file and image attributes from the captured image to the expected data for the image type and/or capture device. As a further example, where a JPEG file is used for a retail check, the data are compared to expected JPEG retail check data defined in the ITID, such as file size range, image size and aspect ratio. Here, the captured image:
a. file size is compared to an expected file size or range (e.g. meta data index for file size based on a given check type and CDID);
b. aspect ratio is compared to an expected aspect ratio; and
c. physical check size is compared to an expected size.

3. QA results from the correlation of the expected data versus actual captured data for the check.

4. If the comparison falls within an expected range the following assumptions can be made:
a. the scan was completed and the resulting image file was as expected;
b. the image size was captured as expected; and
c. the captured image aspect ratio was as expected.

5. The assumptions establish a level of check capture QA and paper check QA.

6. A QA process flow is established where one or more of the comparisons fall outside of the expected range.

7. Exception processing is established to address instances where one or more of the comparisons fall outside of the expected range. Exception processing may include additional tests to determine the problem area prior to flagging the check for paper treatment.

The QA of the present invention is not limited to the examples provided herein. The examples and table above provide a basis for an entire QA process or individual QA elements. The overall process may combine one or more than one element to arrive at a solution and workflow that meets a user's balance of cost, time, risk, and quality. The QA elements are applicable to all types of checks, including but not limited to corporate checks, cash in and out tickets, computer generated checks and the like (See FIG. 5B through FIG. 5E) as well as any paper item with similar capture characteristics. By combining multiple QA elements, a user can create the optimal solution for a given check or item, capture device and overall capture process.

Typical of other examples of processes to establish QA are 1) multiple image comparison, where the paper check is scanned at least two times and the separate images are compared. Correlation establishes that the image capture device is operating within the defined calibration model. Multiple images may also be compared with known test or calibration patterns to compare an overlay (watermark) of one of the scans. Multiple image comparison is used to validate a successful image where the imaging capture device is reliable; and 2) multiple image comparison used to validate the capture device by comparing a scan with a known test pattern to that of data stored in a file representative of an accurate scan of that test pattern by comparing image spatial statistical distribution, meta data capture, calculation and analysis using various algorithms to include neuro networks, fuzzy logic, and quantum statistical analysis on meta data as well as on the actual digital image spatial and quantum characteristics and derived characteristics to include OCR, file size and attributes, SNR, PSNR, mean deviation, and the like.

In an embodiment of the invention, meta data is optionally automatically derived from the capture device or the IMS. Where other meta data already exists in an electronic form, it is migrated rather than re-keyed, to avoid introducing errors. Where new data is required, typing errors are minimized by using check-boxes, drop-down lists and spell-checking facilities.

QA is an integral part of the successful imaging workflow. In the system of the invention, QA is established during the planning stage, documented and included among the project specifications, and implemented throughout the project. QA can be machine and or human based, but allows for operator override to accept or reject an image and/or related data. Where QA standard are too low and allows a faulty image or meta data to bypass exception processing, the system provides reporting to support QA refinement.

The QA component of the invention assures that 1) the check image was captured accurately and an adequate IRD can be created; 2) critical data needed for legal precedent is captured and can be recreated; 3) the image is the original image and it has not been tampered with; 4) an audit trail associated with the capture, manipulation and transmission of all data has been created; and 5) the image and transaction data have been uniquely associated.

Optionally, the system includes a color management system (CMS) based on the International Color Consortium (ICC) color management model. CMS evaluates the color of each scan of a check created by a given device in the workflow and stores the results in color profiles. The profiles can be uniquely linked to the image and enable the color to be automatically adjusted where necessary so that a second device will reproduce the color of the paper check. CMS is used to in normalization and calibration functions and is optionally available to provide a “watermark” on imaged checks.

The image file is subjected to QA prior to the destruction of the original paper check. QA may occur at or using one or more of the image capture device, the teller, a local server, a central server, and or a related location. QA may be accomplished in manual, automated, or combined manual/automated modes. The QA of the invention supports imaging at any point in check processing, including but not limited to the point of presentment (retail and commercial), a high speed processing facility; medium speed commercial capture facility or back office location, attended capture devices, and or unattended capture devices. Quality assurance confirms that the data representing an image and its transfer meet the requirements of current Check 21 mandates, including any future related or non-related requirements, to support a legal challenge.

Exception processing assures that flagged paper checks that do not pass QA are maintained in paper form. Checks falling into the exception process may follow one of many established exception handling processes that may or may not lead to the creation of a suitable electronic check transaction.

Quality assurance confirms that the data needed to support check processing, included but not limited to settlement and clearing is as expected and as needed to support legal and or industry requirements and any legal challenge. Should a check be required to be retrieved from a payor bank facility, quality assurance confirms that the IRD is accurate and or the electronic data is accurate and as expected and sufficient to support a legal challenge. Quality assurance confirms the audit trail and non-repudiation of the check should the check be required to be returned and submitted again for processing (such as payment) and to determine whether a check is being resubmitted for processing after undergoing successful processing.

The QA of the present invention supports the delivery of images and or transaction data related to the paper check to a payor institution following capture, including but not limited to IRD, an electronic image, transaction data, a pointer to the location of the stored data and delivery of the actual data (batch or online). As an example, the QA element supports a bank sending an IRD or printing and sending an IRD to another bank, such as the payor institution.

After the image has been accepted under the appropriate QA standards, the transaction continues in the system for processing. Referring again to FIG. 6, the teller sends the image and transaction data related to the paper check to a applicable local server 210 or 210n for processing. The applicable local server 210 or 210n may be networked to one or more than one teller 200a-200n. The applicable local server 210 or 210n detaches the image 230 from the transaction data related to the paper check 220, digitally signs the transaction using a unique algorithm that includes, but is not limited to, one or more of specifics about the image, the file, time, transaction, terminal, QA, and other elements such that the digital signature can not be recreated without full knowledge of multiple features of the process and the algorithm. This unique digital signature is then used for the creation of the overall transaction signature assuring that the signature is unique to the transaction. The local server also digitally signs each of the items within the file of the transaction data related to the paper check and the image, and then stores each file for further processing. The teller may optionally sign the image, transaction data related to the paper check and or the reintegrated transaction.

The local server forwards the file of the transaction data related to the paper check through a connection or a network to a central server 240, such as the main server of a bank capable of collecting information from multiple local servers 210-210n. The image file may be transmitted in real time as described for the transaction file, or may be stored and transferred as described below.

The central server 240 validates signature on the file containing digital signature on the transaction file 250 and the digital signature on each item in the file to verify that tampering has not occurred between transmission endpoints. The central server 240 dentifies the file containing the transaction data related to the paper check 250 based upon an identifier, such as the RTN and or any other selected parameter(s), and type of transaction. The central server 240 uses configurable sorting and routing algorithms to forward the transaction file, the image file, and or the reintegrated image/data file to one or more targets, such as a validation service 270. The validation service performs a look-up from stored data for the bank and account upon which the check is drawn, compares the items listed in the transaction file (account, amount, item number, etc.) to that found, and validates the information. The validation system can be a network of banks, a contracted service that interfaces with banks, or a Shared Multi-Function Service Network, or the like. FIG. 7.15 is an example of a report of the existing sorting and routing algorithms used by a bank for defining destinations and services based upon RTN and check type, although any parameter may be employed, such as but not limited to bank ID, account ID, payee ID, user ID, user password, teller ID and the like. Algorithms may be constructed pursuant to a Direct Debit Authorization (DDA) between the two bank accounts or any other arrangement between and among banks and or associated organizations.

Upon successful validation 270, the central server 240 stores the image file, and the transaction data file and the unique association between them in a central database 291, stamps the files with a synchronized timestamp and sends a success message to the local server 210 and/or 210n. The applicable local server 210 or 210n receives the message from the central server 240 that the transaction was successful, stamps the locally stored copy of the image file and the transaction file 220 and the unique association between them with a synchronized timestamp and relays the completion of the transaction to the teller 200. In an embodiment, a summary of the completed transaction is displayed at the teller as depicted in FIG. 7.4.

Alternatively, the invention allows for overrides with no validation. As depicted in FIG. 7.5 through FIG. 7.8, when a local server receives and transmits an unknown identifier, such as an RTN not recognized by the existing sorting and routing algorithms, to the central server, the central server rejects the transaction because it cannot determine the transaction's target destination. When the local server receives the rejection from the central server (FIG. 7.6), and transmits the rejection message to the originating teller, the system provides an override option. Additional overrides are available depending upon the bank's policy. A bank may also provide policy for overrides when the network is down, which would allow the teller to override any network based validation. Overrides are tailored to a bank's policy to allow a known customer or payee to transact a check without validation of the check or even if a negative response is received from validation.

To perform the override option, the teller inputs a code/value to override the validation (FIG. 7.7) and transmits the information to the local server, which relays the code/value to the central server. The central server recognizes the code/value as an override and approves the transaction without validation. The override codes/values may be teller derived or determined by the system. The endpoint for an override transaction may be determined from the override code/value internally to the bank or externally, such as through a validation server. If no endpoint for the transaction is determined from the override code/value, the check is routed for exception processing, including but not limited to standard paper processing.

An embodiment of the invention provides an additional security element in the transmission of electronic data associated with a check in multi-application trusted and untrusted networks in Shared Multi-Function Service Networks. In an embodiment, the additional security element is used in bank to bank real time check processing where a first bank requests validation or proceeds with real-time check processing with a second bank. In an embodiment, enterprise rights and privileges are managed at the network level in the form of granted services and activities. Network level management assures that only the overall network administrative entity can see the entire network and resulting business relationships. Such management supports non-repudiation, authentication, authorization and the like for the Network over a common infrastructure.

In an embodiment, each node on the Network can implement additional specific security access privileges for requests made in the Network. The additional security element provides that access allowed to data at a node in the Network is controlled by the node owner in addition to the overall Network administrator. For example, each node administrator can restrict access into that node independent of the Network. Specific access control allows a node administrator to completely control (protect) access to that node's information for any service or activity it provides to any other Network participant.

FIG. 8 is an example of the additional security element of the invention in a basic network with shared services. The Network Administrator (NA) 800 establishes the network through an integration server that defines the structure of the network. The NA server is interconnected to a network access control list (Net-ACL) that grants listed nodes and or users basic permissions in the network, and a System of Record (SOR) that maintains a mapping of permissions granted to nodes/users connected to the network and a log or logs of all activity on the network. The Net-ACL is the superset of all permissions in the network.

FIG. 8 depicts an example showing an external provider 810 and two banks 820a, 820b interconnected to the network; however, the number of interconnected nodes is not limited. Each node 810, 820a, 820b is designated on the Net-ACL as to basic permissions granted. Basic permissions may be granted by the Net-ACL to all nodes and or users, to certain nodes and or users, or to nodes and or users that possess private keys that correspond to public keys listed in the Net-ACL for the permission. In this example, each of the nodes has a Node-ACL, although Node-ACL's may be used by a given subset of nodes or by particular nodes in a network. Each Node-ACL designates specific permissions granted to one or more other nodes and or users in the network when accessing data on that node through the network. The Node-ACL can be configured to grant all permissions to a given node and or user or grant a subset of permissions to designated nodes and or users by making a link accessible by that node/user while denying all other permissions not in the subset.

As an example, Bank A 820a has an agreement with Bank B 820b to allow real time check processing such as but not limited to confirmation of information, such as existing funds in a payee's account, settlement and or clearing and the like. In order for Bank B to get information from Bank A in a traditional network, the NA must establish that Bank B is allowed to access specific services at Bank A, and the network must authenticate and authorize Bank B to access information at Bank A. The invention provides Bank A (at its network integration node) the option to add an additional permission grant on its Node-ACL specific to Bank B that allows Bank B to access a given service at Bank A. Bank A restricts access over and above that granted by the network though its Node-ACL. Nodes cannot establish new rights or privileges that are not part of the superset managed by the network, but may create subsets of Net-ACL permissions.

The additional security element of the present invention assures that members of the network will only know about or be able to grant access to those entities on the network that have an established relationship registered with and granted by the overall network. The Node-ACL may or may not be connected to the Net-ACL and therefore can be configured to act alone or as a receiver of data from the Net-ACL. When configured as a receiver, the Node-ACL can be sent data in band or out of band of the core network to support additional security. Non-receiver Node-ACLs provide a mechanism to update private keys out of band of the core network. Each member in a network may control access to its information without delegating that access control function to a third party.

The security element of the present invention enables each node to create a log to track attempted access, activity of any node/user granted access, and or nodes/users that are requesting access but not granted such privileges. Failed attempts as well as attempts to access without authority are thus monitored. Nodes granting permissions to each other each maintain a record of the other node's attempts and activities at its site. Complete audit logs of all activities can be created unique to each activity on the network. Records of node/user activities can be used to support dispute resolution as well as security and anti-fraud measures.

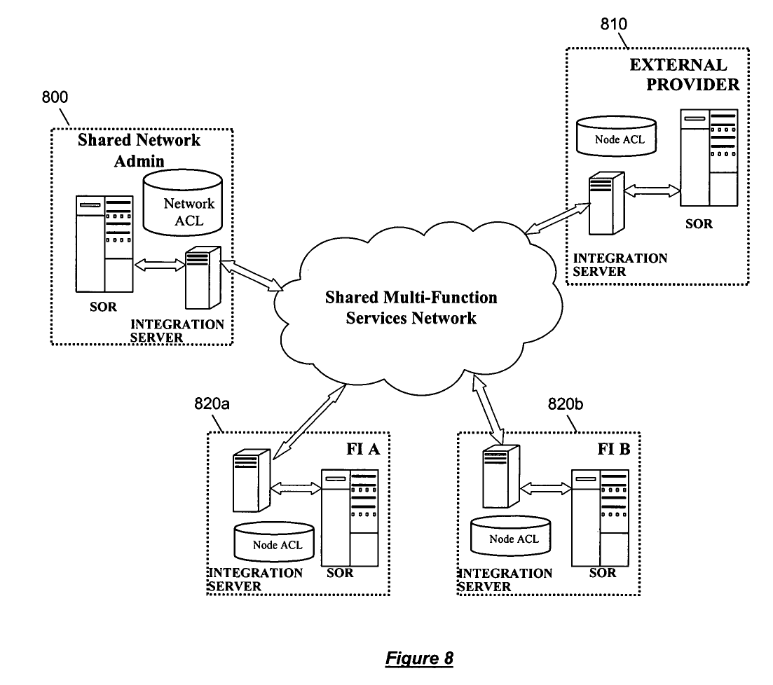

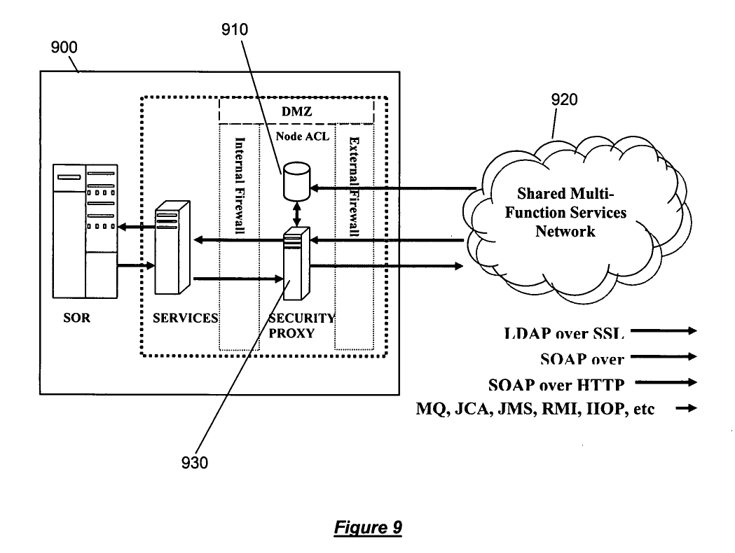

FIG. 9 depicts an example of an attached single integration node 900 with a Node-ACL 910. The node maintains the Node-ACL 910 independent of the network 920. Node 900 uses the Node-ACL 910 in addition to the overall Net-ACL to restrict access to the information located within the node 900 by creating a hierarchy of rules to allow or deny access to applications, users and or nodes. The rules include standards for the network, security, service levels, processing, such as billing and reporting, and or may reference the node IP address that has sent the request and or users, groups, and the like stored in a Lightweight Directory Access Protocol (LDAP). Node-ACL 910 allows the node to control and monitor all attempts and successful access to data it supplies to other network participants and all network participant activity during granted access.

As depicted in the example of FIG. 9, when the node receives a request, the node uses Node-ACL to determine whether to grant access to the node's services and SOR through the security proxy 930. For example, the server may look for an entry and certificate in the LDAP directory that matches the request. If matched, the Node-ACL interfaces with the security proxy to allow the requester entry to the services and records of that node, such to continue real-time check processing, including but not limited to validation of an item in a file of transaction data related to a check.

The Node-ACL rules may optionally use Simple Object Access Protocol (SOAP) to encode the information in the request and response messages via Secured Sockets Layer (SSL) before sending them over a network. Node-ACL distribution can be accomplished in or out of band of the core network with SSL as needed using Web Services, MQ, Java Connector Architecture (JCA), Java Message Service (JMS), Remote Method Invocation (RMI), IIOP, and the like for interactive actions as well as batch data transfers including but not limited to FTP, SFTP, Web Services, Corba Services and the like.

The performance and the interaction of the local and central servers for check processing as shown in the examples are applicable to all types of check processing and among and between any types of banks. The system designates the type of check processing through the use of a code associated with that check type. FIGS. 7.9 and 7.10 depict an example of processing a deposit transaction. Processing is structured to include additional paper items (such as a deposit slip) in imaging. Alternatively, the system may electronically generate additional items based on one or more paper checks scanned into the system.

In an embodiment for a check that is used to deposit an amount, a paper check and a deposit ticket are imaged at the teller and transmitted to a local server for processing as shown in FIG. 7.9. Where the deposit ticket identifier, such as an RTN or the like, is matched to the teller's bank, the transaction is approved (See FIG. 7.10). Alternatively, existing sorting and routing algorithms based on relationships between and among banks allow processing and approval of deposits targeted to other banks and associated institutions.

Referring back to FIG. 1, the image file and or the reintegrated image/data of the check may be printed as a substitute check or IRD at any point in processing after the scan and used for banks that do not have electronic transfer capability. The IRD meets industry standards and procedures relating to check processing, including, but not limited to the notification, presentment, clearing, settlement and adjustments of image-based cash letters and/or deposit tickets. FIGS. 7.16 and 7.17 depict an example of the invention where a check or related document is recreated from the image file and or by reintegrating the stored files of the image and transaction data related to the paper check captured during the scanning step.

In the sequence of FIG. 1, the image or IRD may be archived 6 at any step of check processing. (“Archive” as shown and intended herein includes the immediate or eventual disposal or destruction of a paper check or other instrument.) The file containing the transaction data related to the paper check 10 and the separate image plus data file 11 may be transmitted through a connection or a network to a private or Federal Reserve check clearing, payment and settlement system 20 where traditional cash letters or their electronic equivalent and the like are manipulated and funds representing debits and credits among and between banks are transmitted to payee banks 21, including payee bank 4 from payor banks 22 at which the account associated with the check 2a is maintained.

FIG. 7.18 depicts an example of a cash letter created by the system. The destination routing number and the origination routing number are generated by the system. The system allows for building cash letters based on specific types of transactions, such as traditional checks only, deposits only, cash-in, cash-out, or any combination thereof. Images may optionally be sent with the cash letter. The cash letter may be built at any time, predetermined by the system or selected by an operator, allowing for continuous net settlement. The generated cash letters may be sent through the network or printed, either of which may be used for check processing, such as clearing and/or settlement of a given bank's checks.

As shown in FIG. 7.11, the system tracks transactions at the teller to compile a report, such as a cash balance. The example in FIG. 7.11 depicts two cash-out items associated with a teller. The system tracks the transactions from the initial login cash balance to give real time teller cash positions. The electronic collection of cash-in and cash-out data enables a bank to manage the cash position of a teller, such as a traditional teller window, branch or an ATM to determine if additional cash is needed. A bank can also combine the cash-in and cash-out data of a multiple tellers to create an overall cash position of the bank. For example, where the bank is a merchant with many stores across the world, this option provides the merchant the ability to review the cash position of a single store, a group of selected stores, or the entire organization in real-time or on a predetermined timed basis.

In an example shown in FIG. 6, the file containing the transaction data related to the paper check 250 is used to create account statements 310 for check writers holding an account at the payor bank. As shown in FIG. 1, the payor bank may optionally offer an image of the cancelled check to the payor or print a cancelled check and return it to the payor. The payor bank may archive the image of the check and/or the paper check.

As represented in FIG. 6, the local server 210, 210n has the ability to transmit the file containing the transaction data related to the paper check 220 independently from or simultaneously with the image file of a check. In this example, the image 230 associated with the check is stored at the local server 210 and has not yet been transmitted to the central server 240. The local server 210 may process and transmit many individual files containing transaction data related to paper checks to the central server while retaining the related images at the local server 210. A synchronization agent 290 embedded in the local server 210, 210n transmits one, all or selected images 230 to the central server 240 at any predetermined time or a spontaneous time. The transmission to and from the central server may be performed at a time when the bank is closed or at slow periods so that the transmission of large amounts of data over the connection or network does not interfere with transmission of the transaction data. The time of transmission may be scheduled by the agent 290 or managed by other applications, such as those that monitor network traffic and launch the transmission when bandwidth is adequate.

FIG. 6 depicts an example of transmission of the image file independent of the file containing transaction data related to the paper check. If not sent in real-time with the transaction file, the locally stored image is separately transferred to the central server. The synchronization agent 290 of applicable local server 210 or 210n initiates the transmission of the image file stored locally 230 to the central server 240. Upon arrival at the central server 240, the central image 260 is matched to the transaction file 250a and the signature on the image file 260 is compared to the signature on the transaction file 250a to verify that the image has not been forged or altered. The central image 260 is then matched and integrated into the file containing the transaction data related to the paper check 250a already stored on the central server 240. The image, data and or merged file is distributed to endpoints determined by the bank, such as an archive 291, another bank, related institution and the like.

The present invention offers safeguards to electronic financial transmissions based upon the signatures required to validate IRDs. The digital signatures added to the image and transaction files stored by the system prevent presentment of the same paper check twice and allow for security validation showing that the image file has not been accessed or altered by non-authorized systems or persons.

FIG. 7.12, FIG. 7.13 and FIG. 7.14 show the transmission of a file containing the transaction data related to the paper check separately from the check image file and later linking and integration of the data to the image for that transaction. FIG. 7.12 depicts the data stored in the local server (left) and the central server (right). The local server and the central server each contain the file containing the file of the transaction data related to the paper check. In FIG. 7.12, the local server has processed and transmitted a copy of the transaction file, but has not yet transmitted the image file associated with the transaction. Implementation of the synchronization agent transmits the image file to the central server. FIG. 7.14 depicts the successful transmission and linking of the file containing the transaction data to the image file of that check.

Referring back to FIG. 6, the integrated file stored on the central server is subjected to further check processing, such as but not limited to sorting and printing 293, used for clearing and/or settlement 280, security purposes 294, and/or archived 291.

The system provides an audit trail by logging each transaction and the functions performed for each transaction at each teller. FIG. 7.19 shows an example of electronic and paper reports that may be generated by the system from the logged information. Reports include but are not limited to listings of transactions, transaction items, routings, and images over any given time period. FIG. 7.20 depict an example of a transaction report generated by the system. This example report shows checks sorted by the unique transaction and check type identifier assigned to the transaction.

The invention alternatively receives and processes an electronic transaction from a source performing at least the imaging. In an embodiment, an application, such as software program comprising a synchronization agent receives data comprising an image and information associated with at least one paper document representing an electronic transaction. The application manages the received information, can extract transaction information in support of time sensitive processing and or create and manage separate files from the data received containing the image and the information associated with the document, The application digitally signs each file and or the data, and optionally stores the image file and or the associated information file. The application is capable of sending the separate files to a server in real time or as determined by the synchronization agent. When the files arrive at the server, the digital signatures are validated. Where the associated information file is sent in real time and the image file is sent as determined by the synchronization agent, the server timestamps the associated information file upon arrival and transmits the timestamp to the application where the application applies the timestamp to the image file. When the synchronization agent transmits the image file to the server, the server combines the associated information file and the image file to consolidate the data. The server, which may be in a network, also identifies and requests services from and or routes the associated information file and or the consolidated data to any target.

Thus, the invention provides an implementation of a shared multi-function services network to support electronic check processing utilizing integration nodes as the network interface point. In the system, the integration node implements additional local security restrictions that can be administered separate from the overall network. The integration node 1) performs the functions of security proxy and service interface, 2) implements defined shared services network standards for security, messaging, logging, shared services, performance, PKI, Web Services, exception handling, reporting, and management, 3) supports PKI credential management in and out of the band of the primary network, and 4) supports an ACL list update or synchronization in or out of the band of the primary network. In the server of the Shared Multi-Function Services Network Integration Node, the Integration Node is the boundary between a Network participant's internal trusted network and the Shared Multi-Function Services network all participants access the network through a certified Integration node, and the Integration Node may be deployed as one or more physical nodes. Integration 1) acts as the network interface point to the network, 2) houses and maintains access control and security features of a given implementation, 3) maintains logs for all activity passing through it and attempts for access, 4) implements services that are available to others on the network, 5) implements service requests where services may be requested from other nodes on the network, 6) implements integration services to legacy systems where those systems contain information to be shared to others on the network and 7) implements network administrative services and reporting for the network.

Security functions implemented by the Integration Node include 1) authentication: PKI Digital Certificates are issued and managed via the integration nodes in the shared services network. All requests and responses from integration nodes are digitally signed and verified with a certificate unique to that integration node; 2) authorization: all integration node request and response activities are verified against a known service definition specific and unique to the participants. This information is stored and managed via directory services. There is an additional security option for the network Participant to manage an access control list unique to their node on the network for added control (locks on both sides of the door); 3) non-repudiation: logging of all activity occurs across all nodes in the network. Logs include the Distinguished Name for a given certificate which are tracked for each service invocation; and 5) encryption: https/SSL is supported allowing the utilization of an un-trusted network if needed. Optionally, the integration node supports integration to internal systems. This includes an adapter and data access layer to get data from existing system of record within the participants trusted network so that information can be formatted and shared to requesters on the Mult-Function Shared Services Network.

Having described the invention in detail, those skilled in the art will appreciate that, given the present disclosure modifications may be made to the invention without departing from the spirit of the inventive concept herein described. Therefore, it is not intended that the scope of the invention be limited to the specific and preferred embodiments illustrated and described. Rather it is intended that the scope of the invention be determined by the appended claims.

1. A system for processing a transaction comprising:
a teller comprising an imaging device adapted to a) obtain an image of one or more than one transaction document, and b) optionally (i) recognize one or more field within the document and extract information from the fields and (ii) digitally sign each electronic transaction, and an optional station interconnected to the imaging device and adapted to receive the image and the optional information, the station adapted to a) input information, b) view the image and information c) store the image and information;
a local server comprising a synchronization agent and interconnected to one or more than one teller and adapted to receive the image and information, said local server further adapted to 1) detach the image from the information, 2) create an image file and an information file, 3) digitally sign each file and or the transaction, and 4) store the image file and the information file;
a central server comprising means for storing files and interconnected to one or more than one local server, said central server adapted to receive the image file and the information file, said local server transmitting the information file to the central server in real time and transmitting the image file to the central server in one of a) in real time and b) as determined by the synchronization agent, said central server adapted to a) validate the digital signatures, b) optionally combine the information file and the corresponding image file to recreate the electronic transaction, c) timestamp the information file, d) optionally transmit the timestamp to the local server and e) identify a target for the electronic transaction, said central server optionally interconnected to the target by a network, said central server requesting one or more service from the network target and optionally transmitting the electronic transaction to the network target.

2. The system of claim 1 wherein each interconnection is one of an Internet, an Intranet, a direct link, wireless, a network, and a private portal.

3. The system of claim 1 wherein the teller is one of a teller window, a branch, a point-of-presentment, a point-of-sale, a kiosk, an ATM, a cash vault, a merchant, a corporate location, and an end user.

4. The system of claim 1 wherein the teller comprises a teller identifier.

5. The system for processing a transaction of claim 4 wherein the central server identifies the information file by the identifier.

6. The system of claim 4 wherein the identifier is one or more of a routing transit identifier, a routing transit number, a teller ID, a branch ID, a bank ID, the station ID, a date, a time, a transaction type, a transaction number, a batch number, a network node identifier, and a sequence number.

7. The system of claim 1 wherein the teller is adapted to perform a sign-on function.

8. The system of claim 7 wherein the identifier is initiated by the sign-on.

9. The system of claim 7 wherein the sign-on determines an amount of cash on hand in a cash drawer.

10. The system of claim 9 wherein one or more amount of cash on hand in a cash drawer are combined.

11. The system of claim 7 wherein the sign-on is one of electronic or manual.

12. The system of claim 7 wherein the sign-on is one of a username/password combination, a biometric, and a voice print.

13. The system of claim 1 wherein the teller constructs one or more associated document.

14. The system of claim 13 wherein the associated document comprises a teller identifier.

15. The system of claim 13 wherein the associated document is constructed from information received during a period of time.

16. The system of claim 13 wherein the associated document is one of a cash-in ticket and a cash-out ticket.

17. The system of claim 1 wherein the teller performs one or more function selected from the group an account look up, account status, validation of owner, availability of funds, determination of valid transaction document number, confirmation that a transaction document has not been previously presented, debit an account, credit an account, and memo post.

18. The system of claim 1 wherein the teller identifies each type of transaction.

19. The system of claim 18 wherein the transaction is selected from the group consisting of cashing a check, creating a cash letter, cash in ticket, cash out ticket, payment coupon, data validation, identity validation, biometric capture, and making a cash deposit.

20. The system of claim 1 wherein the system is adapted to provide one or more function from the group consisting of image and information quality assurance, exception processing, security provision, audit, journaling, and image recall.

21. The system claim 1 wherein the information comprises a MICR line and an amount of a financial transaction.

22. The system of claim 1 wherein each digital signature comprises a unique algorithm.

23. The system of claim 22 wherein the unique algorithm consists of one or more of network specifics, user specifics, operator specifics, image specifics, file specifics, time specifics, transaction specifics, terminal specifics, and quality assurance specifics.

24. The system of claim 1 wherein the successful validation of the digital signatures by the central server is a verification that the files have not been altered and or were transmitted from a known source.

25. The system of claim 1 wherein a failed validation of one of the digital signatures by the central server determines that the electronic transaction has been subjected to unauthorized access and or transmitted from an unknown source.

26. The system of claim 1 wherein the central server comprises one or more configurable sorting and routing algorithm adaptable to forward the files to the target.

27. The system of claim 26 wherein the target is one or more of a network node, a printer, a database, a validation service, a security service, clearing and settlement.

28. The system of claim 26 wherein the sorting and routing algorithm is constructed from one or more of a routing transit number, transaction document type, bank ID, account ID, payee ID, user ID, user password, time, network node identifier and teller ID.

29. The system of claim 26 wherein the sorting and routing algorithm is constructed pursuant to a Direct Debit Authorization between at least two bank accounts.

30. The system of claim 27 wherein the target is a validation service and wherein the teller may optionally override validation.

31. The system of claim 30 wherein the override is initiated by electronic or manually input of a value.

32. The system of claim 31 wherein the value determines an endpoint for the transaction.

33. The system of claim 32 wherein the endpoint is an exception processing.

34. The system of claim 33 wherein the exception processing is standard paper transaction processing.

35. The system of claim 27 wherein the validation service is one of a service located at the central server, a network of banks, a contracted service that interfaces with banks, and a Shared Multi-Function Service Network.

36. The system of claim 27 wherein the validation service is adapted to a) compare an item listed in the information file to stored data, and b) return a response that the item is or is not a match.

37. The system of claim 36 wherein the item is one of an account number, an amount, an item number a name, a unique identifier, identifier for authorization, and an identifier for identification.

38. The system of claim 1 wherein the image file is printed as an image replacement document (IRD) as a substitute for the transaction document.

39. The system of claim 38 wherein the IRD meets industry standards and procedures relating to transaction document processing.

40. The system of claim 39 wherein transaction document processing is one of capture, transmission, synchronization, notification, presentment, clearing, settlement, adjustment of a cash letter, a deposit transaction, transaction of information, re-presentment, exception processing, reporting, validating, archiving, retrieval, a credit card transaction, a debit card transaction, manipulating a line of credit, a smart card transaction, privacy and security.

41. The system of claim 38 wherein the IRD is archived at any step in the transaction document processing.

42. The system of claim 38 wherein the IRD is transmitted to a transaction document owner.

43. The system for processing a transaction of claim 1 wherein one or more information file is used to create an account statement.

44. The system of claim 1 wherein the image file is transmitted to and from the central server at a time that does not coincide with transmission of the information file.

45. The system of claim 44 wherein the time is determined when a predetermined network bandwidth is detected by a network traffic monitor.

46. The system of claim 44 wherein the transaction document is transmitted to a second facility prior to imaging.

47. The system of claim 1 wherein the transaction document is one of a check, a deposit slip, a cash letter, a cash in ticket, a cash out ticket, a payment coupon, a loan coupon, security and or privacy information, a credit card, a debit card, a line of credit, and a smart card.

48. The system of claim 1 operatively interconnected with a printer.

49. A method for processing a transaction comprising:
1) imaging one or more than one transaction document at a teller and effecting one of a) extracting information from the image and b) manually inputting information into an electronic format to create an electronic transaction;
2) optionally digitally signing the electronic transaction at the teller;
3) transmitting the electronic transaction to a local server interconnected the teller;
4) detaching the image from the information and optionally creating an image file and an information file at the local server;
5) digitally signing each file and or the transaction at the local server;
6) transmitting the files to a central server interconnected to the local server; said transmission of the files in real-time or as determined by a synchronization agent located at the local server; said image file and information file optionally transmitted to the central server at different times;
7) validating the digital signatures at the central server;
8) and where files are transmitted at separate times, a) timestamping the information file at the central server, b) transmitting the timestamp to the local server, c) transmitting the image file, and d) combining the information file with and the corresponding image file to recreate the electronic transaction at the central server;
9), identifying a target for the electronic transaction, said target optionally connected to the central server in a network; and,
10) optionally effecting one or more of storing, printing, archiving, retrevial, requesting one or more service from the target, and transmitting the electronic transaction to one or more identified target.

50. The method of claim 49 wherein each interconnection is one of wireless, an Internet, an Intranet, a direct link, a network, and a private portal.

51. The method of claim 49 wherein the teller is one of a teller window, a branch, a point-of-presentment, a point-of-sale, a kiosk, an ATM, a cash vault, a merchant, a corporate location, and an end user.

52. The method of claim 49 further comprising the step of creating a teller identifier.

53. The method of claim 51 further comprising the step of identifying the information file transmitted to the central server by the identifier.

54. The method of claim 53 wherein the identifier is one or more of a routing transit identifier, a routing transit number, a teller ID, a branch ID, a bank ID, the station ID, a date, a time, a transaction type, a transaction number, a batch number, a network node identifier, and a sequence number.

55. The method of claim 49 further comprising the step of sign-on at the teller.

56. The method of claim 55 wherein the identifier is created by the sign-on.

57. The method of claim 55 further comprising the step of determining an amount of cash on hand in a cash drawer.

58. The method of claim 57 wherein one or more amount of cash on hand in a cash drawer are combined.

59. The method of claim 55 wherein the sign-on is one of electronic or manual.

60. The method of claim 55 wherein the sign-on is one of a username/password combination, a biometric, and a voice print.

61. The method of claim 49 comprising the step of creating one or more associated document at the teller.

62. The method of claim 61 further wherein the associated document comprises a teller identifier.

63. The method of claim 61 further comprising the step of creating the associated document from information received during a period of time.

64. The method of claim 63 wherein the associated document is one of a cash-in ticket and a cash-out ticket.

65. The method of claim 49 further comprising the step of performing one or more of looking up an account, determining account status, validating an owner, determining an availability of funds, determining a valid transaction document number, confirming that a transaction document has not been previously presented, debiting an account, crediting an account, and posting a memo at the teller.

66. The method of claim 49 further comprising the step of identifying each type of transaction at the teller.

67. The method of claim 66 wherein the transaction is selected from the group consisting of cashing a check creating a cash letter, cash in ticket, cash out ticket, payment coupon, data validation, identity validation, biometric capture, and making a cash deposit.

68. The method of claim 49 further comprising the step of providing one or more of determining image and information quality assurance, exception processing, security, and recalling an image at the teller.

69. The method of claim 49 wherein the information comprises a MICR line and an amount of a financial transaction.

70. The method of claim 49 further comprising the step of creating the digital signature using a unique algorithm.

71. The method of claim 70 wherein the unique algorithm consists of one or more of network specifics, user specifics, operator specifics, image specifics, file specifics, time specifics, transaction specifics, terminal specifics, and quality assurance specifics.

72. The method of claim 49 further comprising the step of verifying files have not been altered and or were transmitted from a known source by validating the digital signatures at the central server.

73. The method of claim 49 further comprising the step of sorting and routing files based on one or more algorithm adaptable to forward the files to the target.

74. The method of claim 73 wherein the sorting and routing algorithm is constructed from one of a routing transit number, time, network node identifier, transaction document type, bank ID, account ID, payee ID, user ID, user password, and teller ID.

75. The method of claim 73 wherein the sorting and routing algorithm is constructed pursuant to a Direct Debit Authorization between at least two bank accounts.

76. The method of claim 73 wherein the target is one or more of a network node, printer, a database, a validation service, a security service, clearing and settlement.

77. The method of claim 76 further comprising the step of overriding the validation service by the teller.

78. The method of claim 77 further comprising the step of initiating the override by an electronic or manual input of a value at the teller.

79. The method of claim 78 including the step of determining an endpoint for the transaction from the value.

80. The method for processing a transaction of claim 78 wherein the endpoint is an exception process.

81. The method for processing a transaction of claim 79 further comprising the step of processing the transaction by standard paper transaction processing.

82. The method of claim 76 wherein the validation service is one of a service located at the central server, a network of banks, a contracted service that interfaces with banks, and a Shared Multi-Function Service Network.

83. The method of claim 76 further including the steps of a) comparing an item listed in the information file to stored data, and b) returning a response that the item is or is not a match to the stored data.

84. The method of claim 83 wherein the item is one of an account number, an amount, an item number a name, a unique identifier, identifier for authorization, and an identifier for identification.

85. The method of claim 49 comprising the step of printing an image replacement document (IRD) from the image file as a substitute for the transaction document.

86. The method of claim 85 wherein the IRD meets industry standards and procedures relating to transaction document processing.

87. The method of claim 86 wherein transaction document processing is one of capture transmission, synchronization, notification, presentment, clearing, settlement, adjustment of a cash letter, a deposit transaction, transaction of information, re-presentment, exception processing, reporting, validating, archiving, retrieval, a credit card transaction, a debit card transaction, manipulating a line of credit, a smart card transaction, privacy and security.

88. The method of claim 49 wherein the image file is translatable as an IRD and the IRD is archived.

89. The method of claim 88 in which the IRD is transmitted to a transaction document owner.

90. The method of claim 49 further comprising the step of creating an account statement from one or more information file.

91. The method of claim 49 further comprising the step of transmitting the image file to and from the central server at a different time than that of transmission of the information file.

92. The method of claim 91 further comprising the step of determining the time by meeting or exceeding a predetermined network bandwidth detected by a network traffic monitor.

93. The method of claim 49 further comprising the step of transmitting the transaction document to a second facility prior to imaging.

94. The method of claim 49 wherein the transaction document is one of a check, a deposit slip, a cash letter, a cash in ticket, a cash out ticket, a payment coupon, a loan coupon, security and or privacy information, a credit card, a debit card, a line of credit, and a smart card.

95. A system for limiting the access of a second participant in a network to a service or an electronic record of a first participant in the network comprising:
a network access control list, said network list storing one or more permission granted to one or more participant in the network; and
a first participant and second participant each interconnected to the network; said first participant creating and maintaining a first participant access control list; said first participant list storing one or more permission granted to one or more second participant; said first participant list granting the same or less than the permissions listed for the second participant on the network list; said first participant created permissions allowing one or more second participant access to one or more service and or record of the first participant.

96. The system of claim 95 wherein the network is a Shared Multi-Function Service Networks.

97. The system of claim 95 further comprising a network System of Record (SOR) comprising a data file for a) maintaining and mapping permissions granted to participants and b) creating a log of all participant activity on the network.

98. The system of claim 95 wherein the participants are banks and the service is real time transaction document processing.

99. The system of claim 95 wherein the service is one of non-repudiation, authentication, and authorization.

100. The system of claim 95 wherein the participant list is a subset of and independent of the network list.

101. The system of claim 100 wherein the first participant restricts a service granted to the second participant with no interaction with the network list.

102. The system of claim 95 wherein network permissions are enforced through a public key and private key infrastructure.

103. The system of claim 95 wherein each participant optionally adds and or deletes one or more permission granted to a second participant, said added or deleted permission being listed on the network list.

104. The system of claim 95 wherein a third participant is unaware of permissions granted by the first participant to the second participant.

105. The system of claim 95 wherein each participant maintains a log of a) attempted access to the service and or record of that participant, and b) the service and or record successfully accessed by the second participant.

106. The system of claim 105 wherein the log is used to support one of dispute resolution, security and anti-fraud measures.

107. The system of claim 95 wherein the network permissions and or the participant permissions are created using a rule hierarchy comprising one or more of a standard for the network, security, service level, and processing.

108. The system of claim 95 wherein permission is determined by matching a digital certificate of a requesting participant to a permission stored in a Lightweight Directory Access Protocol.

109. The system of claim 95 wherein the participant lists use Simple Object Access Protocol to encode the record transmitted in response to the request via Secured Sockets Layer before transmitting over the network.

110. The system of claim 95 wherein the permissions further comprise one or more of Web Services, MQ, Java Connector Architecture, Java Message Service, Remote Method Invocation (RMI), IIOP, FTP, SFTP, and Corba Services.

111. A method of limiting access of a second participant in a network to a service and or an electronic record of a first participant in the network comprising:
1) creating and maintaining a network access control list; said network list storing one or more permission granted to one or more participant in the network; and
2) creating and maintaining a first participant access control list, said first participant list storing one or more permission granted to one or more second participant, said first participant list granting the same or less permissions listed for the second participant on the network list; said first participant permissions allowing one or more second participant access to one or more service and or record of the first participant optionally through a firewall of the first participant.

112. The method of claim 111 wherein the network is a Shared Multi-Function Service Networks.

113. The method of claim 111 further comprising the steps of a) maintaining and mapping permissions granted to participants and b) creating a log of all participant activity on the network.

114. The method of claim 111 wherein the participants are one of banks and related services and the service is real time transaction document processing.

115. The method of claim 111 wherein the service is one of non-repudiation, authentication, and authorization.

116. The method of claim 111 wherein the participant list is a subset of and independent of the network list.

117. The method of claim 116 further comprising the step of restricting a service granted to the second participant with no interaction with the network list by the first participant.

118. The method of claim 116 wherein network permissions are enforced through a public key and private key infrastructure.

119. The method of claim 111 further comprising the step of adding and or deleting one or more permission granted to a second participant by a first participant; said added or deleted permission one of a permission listed on the network list.

120. The method of limiting access of claim 111 wherein a third participant is unaware of the one or more permission granted by the first participant to the second participant.

121. The method of claim 111 further comprising the step of logging a) attempted access to the service and or record of the participant by that participant, and b) the service and or record successfully accessed by one or more second participant.

122. The method of claim 121 wherein the log is used to support one of dispute resolution, security and anti-fraud measures.

123. The method of claim 111 further comprising the step of creating the network permission and or participant permission using a rule hierarchy comprising one or more of a standard for the network, security, service level, and processing.

124. The method of claim 111 further comprising the step of determining permission by matching a digital certificate of a requesting participant to a permission stored in a Lightweight Directory Access Protocol.

125. The method of claim 111 further comprising the step encoding the record transmitted in response to the request use Simple Object Access Protocol via Secured Sockets Layer before transmitting over the network.

126. The method of claim 111 further comprising the step wherein one or more permission further comprise one or more of Web Services, MQ, Java Connector Architecture, Java Message Service, Remote Method Invocation (RMI), IIOP, FTP, SFTP, and Corba Services.

127. A method of assuring the quality of an electronic transaction created from a document comprising:
1) establishing one or more standard;
2) precapturing information associated with a transaction;
3) capturing an electronic transaction of a document including an image and data relating to the document;
4) determining postcapture information from the electronic transaction;
5) determining a quality assurance value from one or more of the precaptured information, and capture information;
6) comparing the value to the standard with the result that the electronic transaction is determined to be acceptable where the value equals or exceed the standard and is rejected where the value is less than the standard.

128. The method of claim 127 using one or more than one attribute to determine the standard.

129. The method of claim 127 wherein the standard is established based on one of human collection, machine collection, and combined collection.

130. The method of claim 127 wherein the rejected electronic transaction is flagged for exception processing.

131. The method of claim 127 wherein the standard is determined by one of a single and a iterative collection of one of the image, the data, and the electronic transaction.

132. The method of claim 127 further comprising the step of depicting an acceptable electronic transaction.

133. The method of claim 132 wherein the depiction is a stamp of approval.

134. The method of claim 127 wherein the establishment of an acceptable or a rejected electronic transaction occurs at any step in the processing of the transaction.

135. The method of claim 134 wherein the step is one of presentment, capture, transfer, printing, clearing, settlement, dispute, storage, and retrieval.

136. The method of claim 127 wherein the document is one of a check, a deposit slip, a cash letter, a cash in ticket, a cash out ticket, a payment coupon, a loan coupon, security and or privacy information, a credit card, a debit card, a line of credit, and a smart card.

137. The method of claim 127 further comprising the steps of enhancing fraud. detection and providing assurance to a recipient that use an electronic version of the transaction document that the electronic transaction is acceptable and unique.

138. The method of claim 127 wherein the standard meets that provided in the Check Truncation Act.

139. The method of claim 127 wherein meta data is used to determine the standard.

140. The method of claim 127 wherein the transaction document is destroyed after establishment of the acceptable image.

141. The method of claim 127 wherein established standards are used.

142. The method of claim 141 wherein the established standards are determined using one or more of any X9B standard and those listed in Table I.

143. The method of claim 127 wherein the standard is determined based on one or more of the type of transaction document and an image capture device ID.

144. The method of claim 127 wherein precapture information determines that the image device is not introducing an unacceptable error into a processing environment.

145. The method of claim 127 wherein the standard is determined based on one or more of established data about the document, image device, capture environment, and expected results.

146. The method of claim 145 wherein established data is related to the document and is one of a check, a deposit slip, a cash letter, a cash in ticket, a cash out ticket, a payment coupon, a loan coupon, security and or privacy information, a credit card, a debit card, a line of credit, and a smart card.

147. The method of claim 145 wherein the established data is on a check and is one or more of MICR string, location of the string, an expected size of the image file, Courtesy Amount Recognition, Legal Amount Recognition, a calibration item, a layout for Optical Character Recognition, and a layout for Intelligent Character Recognition.

148. The method of claim 145 wherein the established data relates to the image device and is one or more of a type of capture device, capture device identification, Capture Device Image Deviation, Signal to Noise Ratio, Peak Signal to Noise Ratio, Modulation Transfer Function, Mean Squared Error, Frequency Distribution, Root Mean Squared Error, Mean Absolute Error, an image file size, Capture Device Quality Index, a Capture Device Image Resolution, and a Capture Device Image Format.

149. The method of claim 145 wherein the established data is related to the capture environment and is one or more of a high speed line, a teller line, a point of sale terminal, an ATM, a date, a time, a location, a device, a process, an image storage format, and capture calibration data.

150. The method of claim 145 wherein the established data is related to the expected results and is one or more of a given Image Type Identification (ITID), CDID, expected Image Quality Index (IQI), expected Image Similarity Index (ISI), expected Image Capture Format (ICF), and expected Image Storage Format (ISF) with file attributes.

151. The method of claim 127 further comprising the step of subjecting a rejected electronic transaction to exception processing.

152. The method of claim 127 wherein acceptable electronic transactions are digitally signed and or watermarked.

153. The method of claim 127 wherein the document is a check, the data collected is at least one of a check number and an account number and an operator manually inputs at least one of a visually perceived check number and account number, the image is an acceptable electronic transaction where the data collected matches the input data.

154. The method of claim 127 wherein an acceptable electronic transaction assures that 1) the electronic transaction was captured accurately and an adequate replacement document can be created; 2) critical data needed for legal precedent is captured and can be recreated; 3) the electronic transaction is the original and has not been tampered with; 4) an audit trail associated with the capture, manipulation and transmission of all data has been created; and 5) the image and data have been uniquely associated.

155. A system for receiving and processing an electronic transaction comprising:
an application comprising a synchronization agent and adapted to receive data related to at least one paper document representing an electronic transaction, said data comprising an image and information associated with the document, said application further adapted to 1) create an image file and a file comprising information associated with the document from the data, 2) digitally sign each file and or the data, and optionally 3) store the image file and or the file comprising information associated with the document; and
a server interconnected to the application, said server configured to receive the image file and the file comprising information associated with the document, said application transmitting the image file and or the file comprising information associated with the document to the server in one of 1) in real time and 2) as determined by the synchronization agent, said server adapted to validate the digital signatures and, where the file comprising information associated with the document is sent in real time and the image file is sent as determined by the synchronization agent, 1) timestamp the file comprising information associated with the document, 2) transmit the timestamp to the application where the application applies the timestamp to the image file, and 3) combine the file comprising information associated with the document and the image file when the image file is received at the server to consolidate the data, said server identifying and routing the file comprising information associated with the document and or the consolidated data to a target.

156. The system of claim 155 wherein the server is interconnected to the target by a network, said server requesting services from the target and or transmitting the file comprising information associated with the document and or the recreated electronic data to the target.

157. The system of claim 95 wherein the participant created permissions pass through a firewall.

158. The method of claim 127 wherein the standard is one of a single value and a range of values.

159. The method of claim 127 wherein the standard is created using one or more of IQV, ITID, IQI, CDI, CDQI, ISI, CDID, IDCR, ICF, ISF, MDCI, MDCV, QACI, and QACV.

160. The method of claim 127 wherein the acceptability is determined by one of a single and a iterative collection of comparing the value to the standard.

161. The method of claim 159 wherein the acceptability is determined by one of a single and a iterative collection of comparing the value to the standard.

162. The method of claim 151 wherein exception processing is one of 1) additional imaging and or 2) additional manual or machine based quality assurance and or 3) flagging the transaction document for paper processing.

163. The method of claim 127 wherein the captured image is segmented into a grid and QA is performed on one or more than one element and or a subset of elements identified in one or more than one segment of the grid.

164. A secured multi-function shared services network for processing an electronic transaction comprising:
at least one participant having one or more service and or record necessary to process an electronic transaction; and
one or more integration node, each linked to participants, said node creating a secured multi-function shared services network by restricting access of said service and or record to the participants.

165. The network of claim 164 wherein the node provides one or more of authentication, authorization, non-repudiation, and or encryption.

166. The network of claim 165 wherein authentication is a public key infrastructure (PKI) and the integration node 1) issues and manages a PKI certificate to the participant making a request not restricted by any security restriction or additional security restriction, 2) digitally signs and verifies each PKI certificate, and 3) logs all PKI certificates used.

167. The network of claim 165 wherein the node provides authorization by 1) verifying one or more request and or response by matching the request and or response to an allowed service definition specific and unique to the participant offering the service, 2) storing and managing the known service definitions in a directory of services, and 3) logging each non-verified and verified request and or response.

168. The network of claim 165 wherein the node provides non-repudiation by issuing a certificate unique to the electronic transaction and tracking and logging all allowed and restricted services used for the transaction and or the associated certificate.

169. The network of claim 165 wherein the node provides encryption supported by https/secured sockets layer for secure transmission of the transaction to an un-trusted network.

170. The network of claim 164 wherein the integration node performs one or more function selected from 1) maintaining a log of all attempts for access to a participant and all requesters allowed to access a participant, 2) implementing services to requesters not restricted by any security restriction or additional security restriction, 3) implementing integration services to an existing system of one or more participant, 4) providing network administrative services and 5) compiling and providing network reports.

171. The network of claim 164 wherein the electronic transaction includes one or more of processing a check, a credit card transaction, a debit card transaction, a loan, a smart card transaction, and an information transaction.

172. The network of claim 171 wherein the electronic transaction is a check and the processing is one or more of writing, receiving, capturing, clearing, settling, transmitting, synchronizing, re-presenting, exception processing, reporting, validating, archiving, printing and retrieving.

173. The network of claim 171 wherein the electronic transaction is an information transaction consisting of comparing one of a name and or an identifier to a known list.

174. The network of claim 164 wherein the integration node performs one or more service consisting of 1) a security proxy and interface, 2) creating and or implementing one or more standard for the network, 3) providing a providing a public key infrastructure (PKI), and 4) updating and or synchronizing the additional security restrictions.

175. The network of claim 174 wherein the standard is used for one of network security, messaging, logging, providing shared services, determining and or optimizing network performance, providing the PKI, providing web services, and or exception handling, reporting and management.

176. The network of claim 164 wherein the participant determines one or more unique additional access restriction to its services and or records through its node.
